(19) United States
(12) Patent Application Publication
(10) Pub. No.: US 2010/0135368 A1
(43) Pub. Date: Jun. 3, 2010

(54) UPSAMPLING/INTERPOLATION AND TIME ALIGNMENT MECHANISM UTILIZING INJECTION OF HIGH FREQUENCY NOISE

(75) Inventors: Jaimin A. Mehta, Plano, TX (US); Sameh S. Rezeq, Dallas, TX (US); Manouchehr Entezari, Highland Village, TX (US); Robert B. Staszewski, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/326,781

(22) Filed: Dec. 2, 2008

(51) Int. Cl. H04B 1/38; G06F 17/17; H04L 25/03

(52) U.S. Cl. 375/219; 708/313; 375/297

(57) ABSTRACT

A novel and useful apparatus for and method of upsampling/interpolating a discrete-time input sample stream with time alignment utilizing the addition of randomized high frequency noise. The upsampling mechanism is an effective implementation of a second order interpolator that eliminates the need for a conventional filter as the filtering action is effectively built into the mechanism. The upsampling mechanism takes the derivative of the discrete-time input sample stream, thereby effectively providing another order of interpolation over a conventional interpolator. Before outputting the interpolated signal, an integrator takes the integral of the interpolated samples. Any processing performed between the derivative and integrator blocks effectively provides an additional order of interpolation. High frequency noise (i.e. dithering) is added to the differentiated samples in order to eliminate the spectral regrowth spurs that would otherwise appear in the output after rounding. Delay alignment is performed on the differentiated samples in order to time align both phase/frequency and amplitude samples that are processed on different paths.

### FIELD OF THE INVENTION

The present invention relates to the field of data communications and more particularly relates to an apparatus for and method of upsampling/interpolating a discrete-time input sample stream with optional time alignment utilizing the addition of randomized high frequency noise.

### BACKGROUND OF THE INVENTION

With the explosive growth of the cellular phone industry, the need has arisen to reduce cost and power consumption of mobile handsets. To keep costs down, the entire radio, including memory, application processor, digital baseband processor, analog baseband and RF circuits, would ideally be all integrated onto a single silicon die with a minimal count of external components. The use of low-voltage nanometer scale CMOS processes allows for an unprecedented degree of scaling and integration in digital circuitry, but complicates implementation of traditional RF circuits. Furthermore, any mask adders for RF/analog circuits within an SoC are not acceptable from an economical cost standpoint.

Consequently, a strong incentive has arisen to find digital architectural solutions to the RF functions. Areas currently in focus are phase/frequency and amplitude modulations of an RF carrier realized using a digitally-controlled oscillator (DCO) and a digitally-controlled power amplifier (DPA) circuits, respectively. They are digitally-intensive equivalents of the conventional voltage-controlled oscillator (VCO) and power amplifier (PA) driver circuits. Due to the fine feature size and high switching speed of the modern CMOS technology, the respective digital-to-frequency conversion (DFC) and digital-to-RF-amplitude conversion (DRAC) transfer functions could be made very linear and of high dynamic range.

A block diagram illustrating an example prior art polar transmitter is shown in FIG. 1. The polar transmitter, generally referenced 10, comprises pulse shaping filter 12, I and Q re-sampling 14, 16, respectively, CORDIC 18, amplitude and phase filter 20, 22, respectively, digital to frequency conversion block (DFC) 25 and Digital to RF amplitude conversion block (DRAC) 24. The DFC 25 comprises a modulator 27 and digitally controlled oscillator (DCO) 28. The DRAC 24 comprises a modulator 26 and digital power amplifier (DPA) 29.

In this example circuit, the sampling frequency used in the pulse shaping filter 12 is a multiple of 270.8333 kHz, the EDGE symbol rate. A sampling frequency of 3.25 MHz is 12 times the symbol rate. Since the transmitter operates on a single clock domain which is a channel based clock referred to as CKVDx, and the closest divided by clock to 3.25 MHz is CKVD512, I and Q re-samplers 14, 16 must be used to move from the fixed clock domain of 3.25 MHz to a channel dependent clock domain.

Polar modulation relies on splitting the digital IQ baseband signal into a phase (i.e. frequency) and amplitude data sample streams. The phase signal θ (or differentiated phase signal (f=Δθ/Δt) ) is used to directly modulate a digitally controlled oscillator (DCO), the output of which is then combined with the amplitude signal ρ in a Digital Power Amplifier (DPA).

The I and Q samples of the Cartesian coordinate system generated in a digital baseband (DBB) are converted through CORDIC algorithm 18 into amplitude and phase samples of the polar coordinate system. The phase is then differentiated to obtain frequency deviation. The polar signals are then conditioned through signal processing to sufficiently increase the sampling rate in order to reduce the quantization noise density and lessen the effects of the modulating spectrum replicas. The frequency deviation output signal is fed into the DCO based DFC 25, which produces a phase modulated (PM) digital carrier

y_{PM}(t)=sgn(cos(ω₀t+θ[k])) (1)

where

sgn(x)=1 for x≧0;

sgn(x)=−1 for x<0;

ω₀=2πf₀ is the angular RF carrier frequency;

θ[k] is the modulating baseband phase of the k^{th} sample.

The phase θ(t)=∫_{-∞}^{t}f(t)dt is an integral of frequency deviation, where t=k·T₀ with T₀ being the sampling period.

The amplitude modulation (AM) signal controls the envelope of the phase-modulated carrier by means of the DPA based DRAC 24. Higher-order harmonics of the digital carrier are filtered out by a matching network so that the sgn( ) operator is dropped. The composite DPA output comprises the desired RF output spectrum.

y_{RF}(t)=a[k]·cos(ω₀t+θ[k]) (2)

where, a[k] is the modulating baseband amplitude of the k^{th} sample.

Note that selecting a low sampling frequency for the pulse shaping filter 12 has the advantage of enabling a small and manageable CORDIC implementation. A sampling frequency of 3.25 MHz is the smallest possible while still maintaining a valid EDGE spectrum from polar amplitude and phase information. The problem with this low sampling frequency, however, is that an image of the spectrum appears at every integer multiple. In an attempt to achieve a receive band free from spectrum replicas and spurs, a final sampling frequency of CKVD16 (close to 104 MHz) in the transmitter was selected.

Filtering out the spectral images at multiples of 3.25 MHz at the last point of sampling (running at 104 MHz) then becomes a challenge. In addition to the requirement of a frequency replica and spur free receive band, attenuation close to −160 dBc/Hz at the RF output port is required over the entire receive band. Thus, the filtering/interpolation performed by amplitude filter 20 and phase/frequency filter 22 must provide sufficient attenuation across the entire receive band. Several prior art approaches that can be used to achieve this are described below.

The first technique uses finite impulse response (FIR) filters. The problem with using FIR filters to remove the spectral replicas, however, is the size of any circuit required for implementation. Several cascaded FIR filters may be used or just one FIR filter having sufficient attenuation starting from 3.25 MHz all the way to Fs/2=104 MHz/2. Either of these FIR filter approaches require the use of multipliers and a large number of coefficients to yield attenuation sufficient in the receive band and the images of 3.25 MHz sampling frequency to meet the requirements.

A second technique uses infinite impulse response (IIR) filters. IIR filters are generally always smaller than FIR filters but they are, however, not small enough. In addition, they exhibit a problem of group delays occurring at the cutoff frequency. If we consider the need to attenuate the image replicas of 3.25 MHz, the group delay problem results in an intolerable degradation in spectrum quality.

A third technique uses interpolators. Although linear interpolators are relatively small in size, they do not provide sufficient attenuation to meet the various receive frequency band specifications. Further, higher order interpolators are complex and difficult and costly to implement. A plot illustrating the frequency response of two prior art interpolators is shown in FIG. 17. The upper trace 380 represents the frequency response of a zero order hold (ZOH) upsampler circuit at Fₛ=104 MHz. The middle trace 382 represents the frequency response of a linear interpolator (first order) circuit at Fₛ=104 MHz. Note that both these frequency response plots are likely to fail to meet EDGE wireless standard requirements.

An additional problem is the time mis-alignment between amplitude and phase after conversion from I and Q by the CORDIC 18 (FIG. 1). A graph illustrating the effect of time misalignment between phase and amplitude on the EDGE spectrum is shown in FIG. 2. In the figure, trace 15 represents the response with perfect alignment; trace 17 represents the response with 6.4 ns mis-alignment; trace 19 represents the response with 13.8 ns mis-alignment; trace 21 represents the response with 19.2 ns mis-alignment; and trace 23 represents the response with 25.6 ns mis-alignment. Non-perfect mis-alignments might cause the transmitter to fail to meet EDGE wireless standard requirements.

It is thus desirable to have a mechanism that overcomes the disadvantage of the prior art techniques. The mechanism should preferably be implementable as a simple, all digital implementation and be capable of eliminating or significantly reducing the spectral replicas caused by I and Q up-sampling and the spectral re-growth caused by rounding in a polar transmitter. In addition, the mechanism should be able to correct for amplitude and phase/frequency mis-alignment of both the timing delay and transfer function, thereby meeting wireless standard performance requirements.

### SUMMARY OF THE INVENTION

The present invention is a novel and useful apparatus for and method of upsampling/interpolating (also referred to simply as “upsampling”) a discrete-time input sample stream with optional time alignment utilizing the addition of randomized high frequency noise. Normally, in a discrete-time signal processing system (analog or digital), spectral replicas are generated since there is no continuous time filtering. One approach to preventing these replicas is to use a sufficiently high enough sample rate at the IQ source (e.g., 100-200 MHz). This approach, however, requires relatively high power consumption and chip area.

Often, signal processing is performed at low frequencies and upsampling/interpolation to higher frequencies is then performed. The upsampling and interpolation from lower frequencies to higher ones results in the generation of frequency spurs at sampling frequencies.

Rather than perform signal processing at high frequencies, a portion of the transmitter (TX) processing chain is implemented and performed at relatively low clock rates (e.g., 1-2 MHz rather than 100-200 MHz) in order to significantly reduce power consumption and chip area, etc. A consequence of performing low clock rate TX processing is to increase the sampling rate to the high variable clock rate of the digital phase locked loop (DPLL). A consequence of the upsampling is that spectral replicas are generated at the sampling frequency. Rather than employ conventional filtering techniques, the present invention provides an upsampling mechanism that is an effective implementation of a second order interpolator that eliminates the need for a conventional filter since the filtering action is effectively built into the mechanism. The mechanism effectively eliminates the generation of frequency spurs at multiples of the sampling frequency during interpolation.

In operation, the upsampling mechanism takes the derivative of the discrete-time input sample stream. This effectively provides another order of interpolation over a conventional interpolator. Before outputting the interpolated signal, an integrator takes the integral of the interpolated samples. Any processing performed between the derivative and integrator blocks effectively provides an additional order of interpolation. High frequency noise (i.e. dithering) is added to the differentiated samples in order to eliminate the spectral re-growth spurs that would otherwise appear in the output after the rounding stage. The spurs that would normally occur from interpolation are spread by the addition of the noise generated via a linear feedback shift register (LFSR). An optional delay alignment is performed on the differentiated samples in order to time align both phase/frequency and amplitude samples that are processed on different paths.

The upsampling mechanism described herein is suitable for use in any application that requires upsampling of a signal from a low fixed clock rate to a high variable clock rate. An example application is provided of a single chip radio, e.g., GSM, WCDMA, etc., that integrates the RF circuitry with the digital base band (DBB) circuitry on the same die.

Although the upsampling mechanism is applicable to numerous wireless communication standards and can be incorporated in numerous types of wireless or wired communication devices such a multimedia player, mobile station, cellular phone, PDA, DSL modem, WPAN device, etc., it is described in the context of a digital RF processor (DRP) based transmitter that may be adapted to comply with a particular wireless communications standard such as GSM, Bluetooth, EDGE, WCDMA, WLAN, WiMax, etc. It is appreciated, however, that the invention is not limited to use with any particular communication standard and may be used in optical, wired and wireless applications.

Several advantages of the upsampling mechanism of the present invention include (1) a significantly lower chip area requirement than prior art interpolators/filters; (2) the elimination of frequency spurs at the sampling frequency which are normally present with prior art interpolators/filters; (3) providing improved and more effective filtering compared to prior art interpolators/filters; and (4) enabling a portion of the transmitter (TX) processing chain to operative at relatively low clock rates (e.g., 1-2 MHz rather than 100-200 MHz) thereby significantly reducing power consumption and chip area.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is thus provided in accordance with the invention, a method of increasing the sampling rate of a discrete-time input sample stream, the method comprising the steps of differentiating the input samples to generate differentiated samples therefrom, upsampling and interpolating the differentiated samples to generate interpolated samples therefrom and integrating the interpolated samples to generate upsampled output samples therefrom.

There is also provided in accordance with the invention, a method of increasing the sampling rate of a discrete-time input sample stream, the method comprising the steps of differentiating the input samples to generate differentiated samples therefrom, upsampling and interpolating the differentiated samples to generate interpolated samples therefrom, delaying the interpolated samples by a predetermined duration to generate delayed samples therefrom and integrating the delayed samples to generate upsampled output samples therefrom.

There is further provided in accordance with the invention, a multi-rate digital filter comprising a differentiator operative to receive a discrete-time input sample stream and to generate differentiated samples therefrom, one or more cascaded upsampling units coupled to the differentiator, each upsampling unit comprising an upsampler operative to upsample and interpolate samples to generate interpolated samples therefrom and an integrator operative to integrate the output of the one or more cascaded upsampling units to generate upsampled output samples therefrom.

There is also provided in accordance with the invention, a multi-rate digital filter comprising a differentiator operative to receive a discrete-time input sample stream and to generate differentiated samples therefrom, one or more cascaded upsampling units coupled to the differentiator, each upsampling unit comprising an upsampler operative to upsample and interpolate samples to generate interpolated samples therefrom, a delay alignment unit operative to delay the interpolated samples by a predetermined duration to generate delayed samples therefrom and an integrator operative to integrate the output of the one or more cascaded upsampling units to generate upsampled output samples therefrom.

There is further provided in accordance with the invention, a polar radio frequency (RF) transmitter (TX) comprising means for generating a discrete-time frequency command word (FCW) signal and a discrete-time amplitude command word (ACW) signal in accordance with input TX IQ data samples, a first multi-rate digital filter operative to increase the sampling rate of the FCW signal by upsampling and interpolating the FCW signal to generate an upsampled FCW signal therefrom, a second multi-rate digital filter operative to increase the sampling rate of the ACW signal by upsampling and interpolating the ACW signal to generate an upsampled ACW signal therefrom, a frequency synthesizer operative to generate an RF signal having a frequency in accordance with a frequency reference input and the upsampled FCW signal and a digital power amplifier (DPA) operative to receive the RF signal and to generate a modulated RF output signal in proportion to the upsampled ACW signal.

There is also provided in accordance with the invention, a single chip radio comprising a phase locked loop (PLL), a transmitter coupled to the phase locked loop, the transmitter comprising means for generating a discrete-time frequency command word (FCW) signal and a discrete-time amplitude command word (ACW) signal in accordance with input transmitter IQ data samples, a first multi-rate digital filter operative to increase the sampling rate of the FCW signal by upsampling and interpolating the FCW signal to generate a filtered FCW signal therefrom, a second multi-rate digital filter operative to increase the sampling rate of the ACW signal by upsampling and interpolating the ACW signal to generate a filtered ACW signal therefrom, a frequency synthesizer operative to generate an RF signal having a frequency in accordance with a frequency reference input and the filtered FCW signal, a digital power amplifier (DPA) operative to receive the RF signal and to generate a modulated RF output signal in proportion to the filtered amplitude command signal, a receiver coupled to the phase locked loop and a baseband processor coupled to the transmitter and the receiver.

### BRIEF DESCRIPTION OF THE DRAWINGS

The invention is herein described, by way of example only, with reference to the accompanying drawings, wherein:

FIG. 1 is a block diagram illustrating an example prior art polar transmitter;

FIG. 2 is a graph illustrating the effect of time misalignment between phase and amplitude on the EDGE spectrum;

FIG. 3 is a block diagram illustrating an example single chip radio incorporating the upsampling mechanism of the present invention;

FIG. 4 is a simplified block diagram illustrating an example mobile communication device incorporating the upsampling mechanism of the present invention within multiple radio transceivers;

FIG. 5 is a block diagram illustrating an example ADPLL-based polar transmitter suitable for use with the present invention;

FIG. 6 is a block diagram illustrating a first example embodiment of the upsampling mechanism of the present invention;

FIG. 7 is a block diagram illustrating a second example embodiment of the upsampling mechanism of the present invention;

FIG. 8 is a block diagram illustrating the upsample processing unit of FIG. 7 in more detail;

FIG. 9 is a block diagram illustrating the upsample processing unit of FIG. 7 incorporating delay alignment in more detail;

FIG. 10 is a flow diagram illustrating the upsampling method of the present invention;

FIG. 11 is a diagram illustrating an example differentiator of the present invention;

FIG. 12 is a diagram illustrating an example interpolator of the present invention;

FIG. 13 is a diagram illustrating an example integrator of the present invention;

FIG. 14 is a block diagram illustrating a portion of a polar transmitter signal path incorporating the upsampling mechanism of the present invention;

FIG. 15 is a block diagram illustrating a third example embodiment of the upsampling mechanism of the present invention;

FIG. 16 is a block diagram illustrating a fourth example embodiment of the upsampling mechanism of the present invention;

FIG. 17 is a plot illustrating the frequency response of the interpolator of the present invention compared with prior art interpolators;

FIG. 18 is a graph illustrating an ACW sampling replica and transfer function notches of the interpolator of the present invention compared to that of prior art interpolators;

FIG. 19 is a graph illustrating the ACW spectrum of the output of the upsampler of the present invention before and after rounding of three LSBs;

FIG. 20 is a graph illustrating example high pass random noise that is injected in each processing stage; and

FIG. 21 is an example amplitude control word (ACW) spectral plot with and without the addition of noise in the interpolator stages of the upsampler.

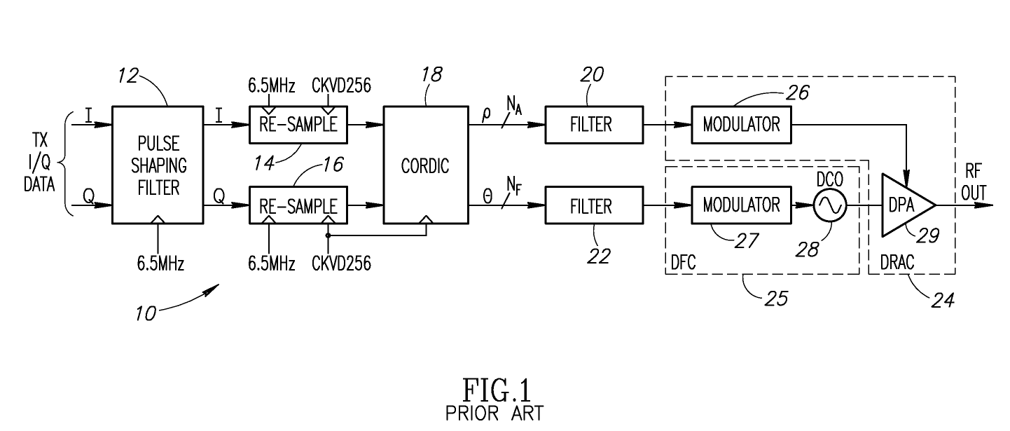

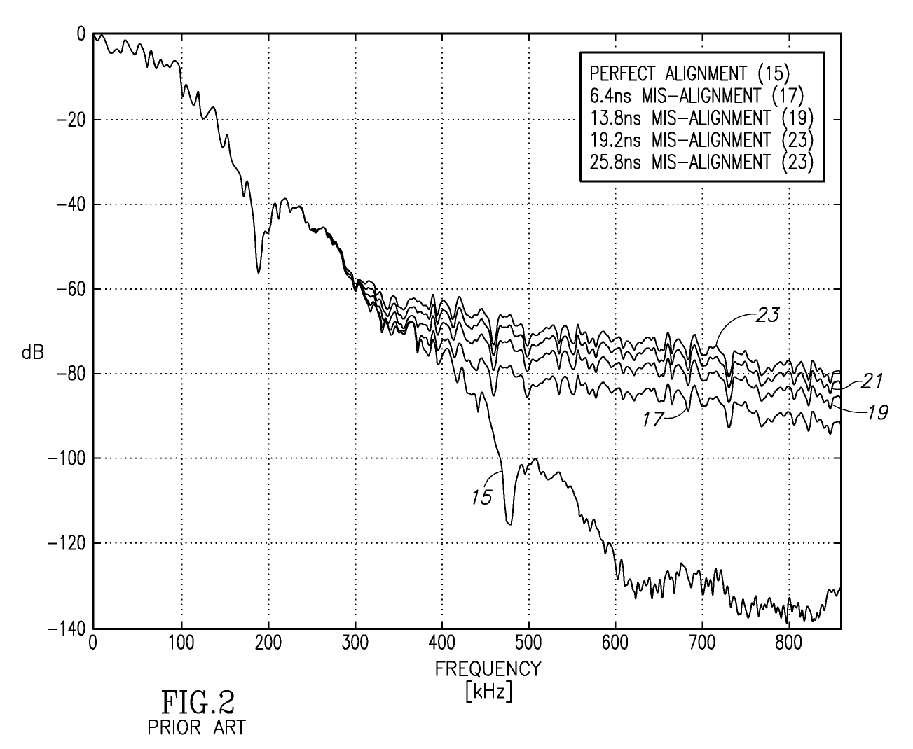

### DETAILED DESCRIPTION OF THE INVENTION

### Notation Used Throughout

The following notation is used throughout this document.

| Term | Definition |
|---|---|
| AC | Alternating Current |
| ACW | Amplitude Control Word |
| ADC | Analog to Digital Converter |
| ADPLL | All Digital Phase Locked Loop |
| AM | Amplitude Modulation |
| ASIC | Application Specific Integrated Circuit |
| AVI | Audio Video Interface |
| BIST | Built-In Self Test |
| BMP | Windows Bitmap |
| CMOS | Complementary Metal Oxide Semiconductor |
| CPU | Central Processing Unit |
| DAC | Digital to Analog Converter |
| dB | Decibel |
| DBB | Digital Baseband |
| DC | Direct Current |
| DCO | Digitally Controlled Oscillator |
| DCXO | Digitally Controlled Crystal Oscillator |
| DFC | Digital-to-Frequency Conversion |
| DPA | Digitally Controlled Power Amplifier |
| DPLL | Digital Phase Locked Loop |
| DPPA | Digital Pre-Power Amplifier |
| DRAC | Digital to RF Amplitude Conversion |
| DRP | Digital RF Processor or Digital Radio Processor |
| DSL | Digital Subscriber Line |
| DSP | Digital Signal Processor |
| EDGE | Enhanced Data Rates for GSM Evolution |
| EDR | Enhanced Data Rate |
| EEPROM | Electrically Erasable Programmable Read Only Memory |
| EPROM | Erasable Programmable Read Only Memory |
| FCC | Federal Communications Commission |
| FCW | Frequency Command Word |
| FEM | Front End Module |
| FIR | Finite Impulse Response |
| FM | Frequency Modulation |
| FPGA | Field Programmable Gate Array |
| GMSK | Gaussian Minimum Shift Keying |
| GPRS | General Packet Radio Service |
| GPS | Global Positioning System |
| GSM | Global System for Mobile communications |
| HB | High Band |
| HDL | Hardware Description Language |
| iADPLL | Interpolative All Digital Phase Locked Loop |
| IC | Integrated Circuit |
| IEEE | Institute of Electrical and Electronics Engineers |
| IIR | Infinite Impulse Response |
| JPG | Joint Photographic Experts Group |
| LAN | Local Area Network |
| LB | Low Band |
| LDO | Low Drop Out |
| LFSR | Linear Feedback Shift Register |
| LO | Local Oscillator |
| LPF | Low Pass Filter |
| LSB | Least Significant Bit |
| MAC | Media Access Control |
| MAP | Media Access Protocol |
| MIM | Metal Insulator Metal |
| Mod | Modulo |
| MOS | Metal Oxide Semiconductor |
| MOSCAP | MOS Capacitor |
| MP3 | MPEG-1 Audio Layer 3 |
| MPG | Moving Picture Experts Group |
| MUX | Multiplexer |
| OFDM | Orthogonal Frequency Division Multiplexing |
| OTW | Oscillator Tuning Word |
| PA | Power Amplifier |
| PC | Personal Computer |
| PCI | Personal Computer Interconnect |
| PCS | Personal Communications Service |
| PDA | Personal Digital Assistant |
| PLL | Phase Locked Loop |
| PM | Phase Modulation |
| PNA | Personal Navigation Assistant |
| PPA | Pre-Power Amplifier |
| RAM | Random Access Memory |
| RAT | Radio Access Technology |
| RF | Radio Frequency |
| RFBIST | RF Built-In Self Test |
| ROM | Read Only Memory |
| SAM | Sigma-Delta Amplitude Modulation |
| SAW | Surface Acoustic Wave |
| SIM | Subscriber Identity Module |
| SoC | System on Chip |
| SPI | Serial Peripheral Interface |
| SRAM | Static Read Only Memory |
| SYNTH | Synthesizer |
| TDC | Time to Digital Converter |
| TDD | Time Division Duplex |
| TV | Television |
| USB | Universal Serial Bus |
| UWB | Ultra Wideband |
| VCO | Voltage Controlled Oscillator |
| WCDMA | Wideband Code Division Multiple Access |
| WiFi | Wireless Fidelity |
| WiMAX | Worldwide Interoperability for Microwave Access |
| WiMedia | Radio platform for UWB |
| WLAN | Wireless Local Area Network |
| WMA | Windows Media Audio |
| WMAN | Wireless Metropolitan Area Network |
| WMV | Windows Media Video |
| WPAN | Wireless Personal Area Network |
| ZIF | Zero IF |
| ZOH | Zero Order Hold |

### DETAILED DESCRIPTION OF THE INVENTION

The present invention is a novel and useful apparatus for and method of upsampling/interpolating (also referred to simply as “upsampling”) a discrete-time input sample stream with optional time delay (used for a system-level alignment) utilizing the addition of randomized high frequency noise. Normally, in a discrete-time system (analog or digital), spectral replicas are generated since there is no continuous time filtering. One approach to avoiding these replicas is to use a sufficiently high enough sample rate at the IQ source (e.g., 100-200 MHz). This approach, however, requires relatively high power consumption and chip area.

Instead, a portion of the transmitter (TX) processing chain is implemented and performed at relatively low clock rates (e.g., 1-2 MHz rather than 100-200 MHz) in order to significantly reduce power consumption and chip area, etc. A consequence of performing low clock rate TX processing is that upsampling is required to increase the sampling rate to the high variable clock rate of the digital phase locked loop (DPLL). A consequence of the upsampling is that spectral replicas are generated at the sampling frequency. Rather than employ conventional filtering techniques, the present invention provides an upsampling mechanism that is an effective implementation of a second order interpolator that eliminates the need for a conventional filter since the filtering action is effectively built into the mechanism.

The upsampling mechanism described herein is suitable for use in any application that requires upsampling of a signal from a low fixed clock rate to a high variable clock rate. An example application is provided of a single chip radio, e.g., GSM, WCDMA, etc., that integrates the RF circuitry with the digital base band (DBB) circuitry on the same die.

Although the upsampling mechanism is applicable to numerous wireless communication standards and can be incorporated in numerous types of wireless or wired communication devices such a multimedia player, mobile station, cellular phone, PDA, DSL modem, WPAN device, etc., it is described in the context of a digital RF processor (DRP) based transmitter that may be adapted to comply with a particular wireless communications standard such as GSM, Bluetooth, EDGE, WCDMA, WLAN, WiMax, etc. It is appreciated, however, that the invention is not limited to use with any particular communication standard and may be used in optical, wired and wireless applications.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, WiMAX, WiMedia, WiFi, or any other broadband medium, etc. Examples of wired media include twisted pair, coaxial, optical fiber, any wired interface (e.g., USB, Firewire, Ethernet, etc.). The term Ethernet network is defined as a network compatible with any of the IEEE 802.3 Ethernet standards, including but not limited to 10 Base-T, 100 Base-T or 1000 Base-T over shielded or unshielded twisted pair wiring. The terms communications channel, link and cable are used interchangeably. The notation DRP is intended to denote either a Digital RF Processor or Digital Radio Processor. References to a Digital RF Processor infer a reference to a Digital Radio Processor and vice versa.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal navigation assistants (PNAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Single Chip Radio

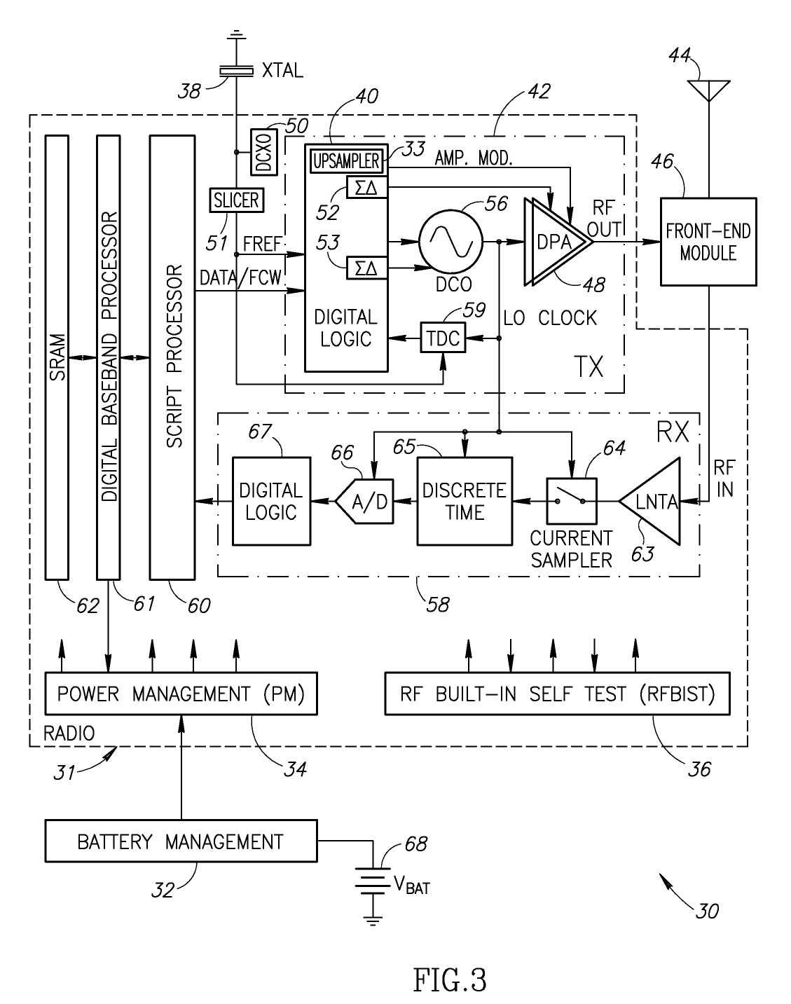

A block diagram illustrating an example single chip radio incorporating the upsampling mechanism of the present invention is shown in FIG. 3. For illustration purposes, the transmitter may be is adapted for any desired cellular standard, e.g., WCDMA, GSM/EDGE, etc. It is appreciated, however, that one skilled in the communication arts can adapt the transmitter illustrated herein to other modulations and communication standards as well without departing from the spirit and scope of the present invention.

The radio circuit, generally referenced 30, comprises a single chip radio integrated circuit (IC) 31 coupled to a crystal 38, front end module (FEM) 46, antenna 44 and battery management circuit 32 connected to a battery 68. The radio chip 31 comprises a script processor 60, digital baseband (DBB) processor 61, memory 62 (e.g., static RAM), TX block 42, RX block 58, digitally controlled crystal oscillator (DCXO) 50, FREF slicer 51, power management unit 34 and RF built-in self test (BIST) 36. The TX block comprises high speed and low speed digital logic block 40 including upsampler or multirate digital filter block 33, ΣΔ modulators 52, 53, digitally controlled oscillator (DCO) 56, TDC 59 and digitally controlled power amplifier (DPA) or pre-power amplifier (PPA) 48. The ADPLL and transmitter generate various radio frequency signals. The RX block comprises a low noise transconductance amplifier 63, current sampler 64, discrete time processing block 65, analog to digital converter (ADC) 66 and digital logic block 67 for the digital processing of the recovered signal in the receiver.

In accordance with the invention, the radio comprises a digital filter block 33 operative to implement the upsampling mechanism with optional time alignment utilizing the injection of high frequency noise. The upsampling block may be implemented in hardware, software or a combination of hardware and software. Alternatively, the upsampling block may be implemented as one or more software tasks on the script processor.

The structure presented herein has been used to develop multiple generations of a Digital RF Processor (DRP) for single-chip Bluetooth, GSM, GSM/EDGE and WCDMA radios which may be realized in 130 nm, 90 nm, 65 nm, 45 nm digital CMOS process technologies, for example. The common architecture is highlighted in FIG. 3 with features added specific to the cellular radio, such as the DCXO. The all digital phase locked loop (ADPLL) based transmitter employs a polar architecture with all digital phase/frequency and amplitude modulation paths. The receiver employs a discrete-time architecture in which the RF signal is directly sampled and processed using analog and digital signal processing techniques.

A key component is the digitally controlled oscillator (DCO) 56, which avoids any analog tuning controls. A digitally-controlled crystal oscillator (DCXO) generates a high-quality base-station-synchronized frequency reference such that the transmitted carrier frequencies and the received symbol rates are accurate to within 0.1 ppm. Digital logic built around the DCO realizes an all-digital PLL (ADPLL) that is used as a local oscillator for both the transmitter and the receiver. The polar transmitter architecture utilizes the wideband direct frequency modulation capability of the ADPLL and a digitally controlled power amplifier (DPA) 48 for the amplitude modulation. The DPA operates in near-class-E mode and uses an array of nMOS transistor switches to regulate the RF amplitude and acts as a digital-to-RF amplitude converter (DRAC). It is followed by a matching network and an external front-end module 46, which comprises a power amplifier (PA), a transmit/receive switch for the common antenna 44 and RX surface acoustic wave (SAW) filters. Fine amplitude resolution is achieved through high-speed ΣΔ dithering of the DPA nMOS transistors.

The receiver 58 employs a discrete-time architecture in which the RF signal is directly sampled at the Nyquist rate of the RF carrier and processed using analog and digital signal processing techniques. The transceiver is integrated with a script processor 60, dedicated digital base band processor 61 (i.e. ARM family processor and/or DSP) and SRAM memory 62. The script processor handles various TX and RX calibration, compensation, sequencing and lower-rate data path tasks and encapsulates the transceiver complexity in order to present a much simpler software programming model.

The frequency reference (FREF) is generated on-chip by a 26 MHz (could be 38.4 MHz or other) digitally controlled crystal oscillator (DCXO) 50 coupled to slicer 51. An integrated power management (PM) system is connected to an external battery management circuit 32 that conditions and stabilizes the supply voltage. The PM comprises multiple low drop out (LDO) regulators and switchers that provide internal supply voltages and also isolate supply noise between circuits. The RF built-in self-test (RFBIST) 36 performs autonomous phase noise and modulation distortion testing, and various loopback configurations for transmitter and receiver tests. The transceiver is integrated with the digital baseband and SRAM in a complete system-on-chip (SoC) solution. Almost all the clock signals on this SoC are derived from and are synchronous to the RF oscillator clock. This helps to reduce susceptibility to the noise generated through clocking of the massive digital logic.

The transmitter comprises a polar architecture in which the amplitude and phase/frequency modulations are implemented in separate paths. Transmitted symbols generated in the digital baseband (DBB) processor are first pulse-shape-filtered in the Cartesian coordinate system. The filtered in-phase (I) and quadrature (Q) samples are then converted through a CORDIC algorithm into amplitude and phase samples of the polar coordinate system. The phase is then differentiated to obtain frequency deviation. The polar signals are subsequently conditioned through signal processing to sufficiently increase the sampling rate in order to reduce the quantization noise density and lessen the effects of the modulating spectrum replicas.

A more detailed description of the operation of the ADPLL can be found in U.S. Patent Publication No. 2006/0033582A1, published Feb. 16, 2006, to Staszewski et al., entitled “Gain Calibration of a Digital Controlled Oscillator,” U.S. Patent Publication No. 2006/0038710A1, published Feb. 23, 2006, to Staszewski et al., entitled “Hybrid Polar/Cartesian Digital Modulator” and U.S. Pat. No. 6,809,598, to Staszewski et al., entitled “Hybrid Of Predictive And Closed-Loop Phase-Domain Digital PLL Architecture,” all of which are incorporated herein by reference in their entirety.

### Mobile Device/Cellular Phone/PDA/PNA

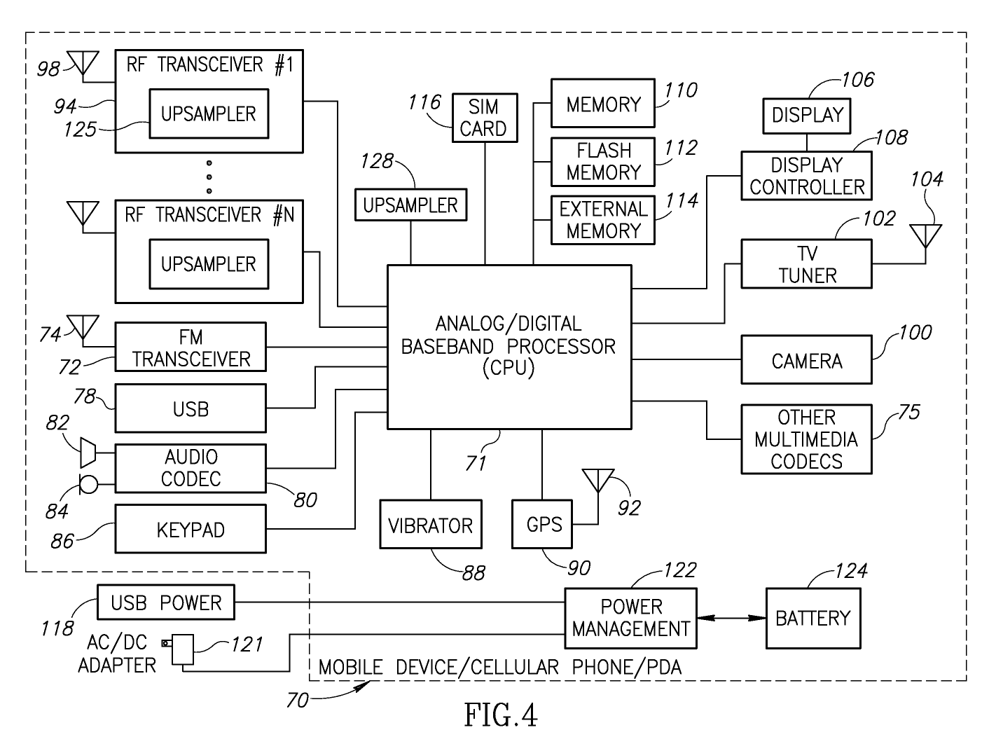

A simplified block diagram illustrating an example mobile communication device incorporating the upsampling mechanism of the present invention within multiple radio transceivers is shown in FIG. 4. Note that the mobile device may comprise any suitable wired or wireless device such as multimedia player, mobile communication device, cellular phone, smartphone, PDA, PNA, Bluetooth device, etc. For illustration purposes only, the device is shown as a mobile device, such as a cellular phone. Note that this example is not intended to limit the scope of the invention as the upsampling mechanism of the present invention can be implemented in a wide variety of communication devices.

The mobile device, generally referenced 70, comprises a baseband processor or CPU 71 having analog and digital portions. The mobile device may comprise a plurality of RF transceivers 94 and associated antennas 98. RF transceivers for the basic cellular link and any number of other wireless standards and Radio Access Technologies (RATs) may be included. Examples include, but are not limited to, Global System for Mobile Communication (GSM)/GPRS/EDGE 3G; WCDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; UWB; etc. One or more of the RF transceivers may comprise additional antennas to provide antenna diversity which yields improved radio performance. The mobile device may also comprise internal RAM and ROM memory 110, Flash memory 112 and external memory 114.

Several user-interface devices include microphone(s) 84, speaker(s) 82 and associated audio codec 80 or other multimedia codecs 75, a keypad 86 for entering dialing digits and for other controls and inputs, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM transceiver 72 and antenna 74 provide the user the ability to listen to FM broadcasts as well as the ability to transmit audio over an unused FM station at low power, such as for playback over a car or home stereo system having an FM receiver. SIM card 116 provides the interface to a user's SIM card for storing user data such as address book entries, user identification, etc.

The RF transceivers 94 also comprise the upsampling (or multirate digital filtering) mechanism 125 of the present invention. Alternatively (or in addition to), the upsampling mechanism may be implemented as a task 128 executed by the baseband processor 71. The upsampling blocks 125, 128 are adapted to implement the upsampling mechanism of the present invention as described in more detail infra. In operation, the upsampling mechanism may be implemented as hardware, software or as a combination of hardware and software. Implemented as a software task, the program code operative to implement the upsampling mechanism of the present invention is stored in one or more memories 110, 112 or 114 or local memories within the baseband.

Portable power is provided by the battery 124 coupled to power management circuitry 122. External power is provided via USB power 118 or an AC/DC adapter 121 connected to the battery management circuitry 122, which is operative to manage the charging and discharging of the battery 124.

### ADPLL Based Polar Transmitter

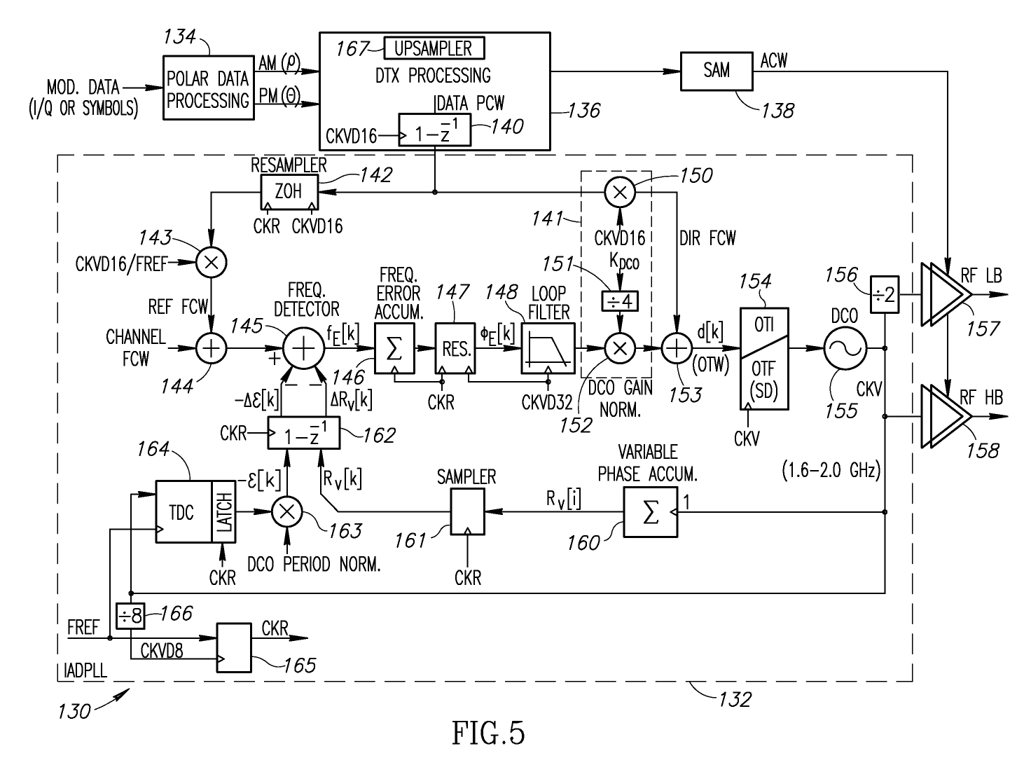

A block diagram of an iADPLL used in the radio of FIG. 3 and suitable for use with the upsampling mechanism of the present invention is shown in FIG. 5. For illustration purposes only, the transmitter of the present embodiment is adapted for the GSM/EDGE cellular standard. It is appreciated, however, that one skilled in the communication arts can adapt the transmitter illustrated herein to other modulations and communication standards as well without departing from the spirit and scope of the present invention.

A more detailed description of the operation of an ADPLL can be found in U.S. Patent Publication No. 2006/0033582A1, published Feb. 16, 2006, to Staszewski et al., entitled “Gain Calibration of a Digital Controlled Oscillator,” U.S. Patent Publication No. 2006/0038710A1, published Feb. 23, 2006, to Staszewski et al., entitled “Hybrid Polar/Cartesian Digital Modulator” and U.S. Pat. No. 6,809,598, to Staszewski et al., entitled “Hybrid Of Predictive And Closed-Loop Phase-Domain Digital PLL Architecture,” all of which are incorporated herein by reference in their entirety.

A more detailed description of the operation of the iADPLL can be found in U.S. application Ser. No. 12/022,931, to Waheed et al., entitled “Interpolative All-Digital Phase Locked Loop,” incorporated herein by reference in its entirety.

A description of the iADPLL, generally referenced 130, including the frequency/phase modulation path is provided herein below. The core of the iADPLL is a digitally controlled oscillator (DCO) 155 adapted to generate the RF oscillator clock CKV. The oscillator core (not shown) operates at twice the 1.6-2.0 GHz high frequency band or four times the 0.8-1.0 GHz low frequency band. The output of the DCO is then divided for precise generation of RX quadrature signals, and for use as the transmitter's carrier frequency. For GSM/EDGE transceivers, a single DCO is shared between transmitter and receiver and is used for both the high frequency bands (HB) and the low frequency bands (LB). For modern 3G (WCDMA) or other duplex transmission systems, however, separate local oscillators might be needed to supply TX and RX carrier frequencies.

A digitally controlled oscillator (DCO) 155 lies at the heart of the interpolated all-digital PLL (iADPLL) frequency synthesizer. It deliberately avoids any analog tuning voltage controls and is realized as an ASIC cell with truly digital inputs and outputs. The DCO comprises tunable switchable varactor elements, cross-coupled pairs of NMOS transistors and a biasing circuit. The DCO varactors may be realized as n-poly/n-well MOS capacitor (MOSCAP) devices that operate in the flat regions of their C-V curves. Current advanced CMOS process lithography allows creation of extremely small-size but well-controlled varactors. The switchable capacitance of the finest differential TB varactor is in tens of attofarads. This resolution, however, is still too coarse for wireless applications and requires high-speed ΣΔ dithering to enhance the time-averaged frequency resolution. The output of the DCO is input to the RF high band power amplifier 158. It is also input to the RF low band power amplifier 157 after divide by two in divider 156.

In case of transmit modulation, the symbols (for example GSM, EDGE) or chips (for example WCDMA.), in the form of in-phase and quadrature data streams are received from the digital baseband (DBB) circuit (not shown). The GSM symbols are passed through a pulse-shaping filter (PSF) within processor 134 that converts it to phase modulation. This phase modulation is upsampled and interpolated in transmit data (DTX) processing circuit 136 (via upsampler 167 constructed in accordance with the present invention) and then passed to the iADPLL after differentiation at the CKVD16 clock rate using differentiator 140. CKV is the iADPLL RF output digital variable clock in case of high bands (HB>1 GHz) or twice the RF output clock in case of low band (LB<1 GHz).

For the case of EDGE, WCDMA, etc. the complex modulation I/Q data streams are fed to a COordinate Rotation DIgital Computer (CORDIC) within processor 134, which converts it from Cartesian to polar representation. The amplitude modulation signal is passed through sigma-delta amplitude (SAM) signal processing block 138 before they are passed onto the on-chip digital pre-power amplifier (DPA) 157, 158, while the phase modulation output of the cordic is passed to the iADPLL 132 (after the necessary interpolation and signal processing) which performs the phase modulation of the DCO.

Under normal modulation conditions, the iADPLL digitally controls the DCO to produce a stable variable clock (CKV) in the targeted RF frequency band. In the feedback path, CKV is used for phase detection and reference retiming. The time to digital phase conversion in the feedback is achieved using a TDC inverter chain 164.

The channel and data frequency control words are in the frequency command word (FCW) format, which is defined as the fractional frequency division ratio N, with a fine frequency resolution limited only by the FCW word length. For example, with 24 fractional FCW bits, the frequency granularity using a 38.4 MHz reference frequency is 38.4 MHz/2²⁴=2.29 Hz. In this embodiment, the direct point frequency injection is at CKVD16 (which is 1×HB/2×LB channel frequency divided by 16, i.e. CKVD16=fᵥ/16) rate, so the possible DCO frequency resolution is in the range of 6˜7.5 Hz (computed as

$$\frac{{f}_{v} / 16}{{2}^{24}} ) .$$

The expected variable frequency f_{V} at the DCO output is related to the reference frequency f_{R} by the frequency command word (FCW).

$$FCW [ k ] ≡ \frac{E ( {f}_{V} [ k ] )}{{f}_{R}} \qquad ( 3 )$$

The FCW is time variant and is allowed to change with every cycle T_{R}=1/f_{R} of the frequency reference clock. With W_{F}=24 the word length of the fractional part of FCW, the ADPLL provides fine frequency control with 1.5 Hz accuracy, according to:

$$Δ {f}_{res} = \frac{{f}_{R}}{{2}^{{W}_{F}}} \qquad ( 4 )$$

The number of integer bits W_{I}=8 has been chosen to fully cover the GSM/EDGE and partial WCDMA band frequency range of f_{V}=1,600-2,000 MHz with an arbitrary reference frequency f_{R}≧8 MHz.

The iADPLL operates in a digitally-synchronous fixed-point phase domain as follows. The variable phase accumulator 160 determines the variable phase R_{V}[i] by counting the number of rising clock transitions of the DCO oscillator clock CKV as expressed below.

$${R}_{V} [ i ] = {\sum }_{l = 0}^{i} 1 \qquad ( 5 )$$

The index i indicates the DCO edge activity. The variable phase R_{V}[i] is sampled via sampler 161 to yield sampled FREF variable phase R_{V}[k], where k is the index of the FREF edge activity. The sampled FREF variable phase R_{V}[k] is fixed-point concatenated with the normalized time-to-digital converter (TDC) 164 output ε[k]. The TDC measures and quantizes the time differences between the frequency reference FREF and the DCO clock edges. The sampled differentiated (via block 162) variable phase is subtracted from the frequency command word (FCW) by the digital frequency detector 145. The frequency error f_{E}[k] samples

f_{E}[k]=FCW−[(R_{V}[k]−ε[k])−(R_{V}[k−1]ε[k−1])] (6)

are accumulated via the frequency error accumulator 146 to create the phase error φ_{E}[k] samples

$${φ}_{E} [ k ] = {\sum }_{l = 0}^{k} {f}_{E} [ k ] \qquad ( 7 )$$

which are then filtered by a fourth order IIR loop filter 148 and scaled by a proportional loop attenuator α. A parallel feed with coefficient ρ adds an integrated term to create type-II loop characteristics which suppress the DCO flicker noise.

The loop behavior due to its digital nature is independent of process, voltage and temperature variations. The FREF retiming quantization error ε[k] is determined by the time-to-digital converter (TDC) 164 and the DCO period normalization multiplier 163. The TDC is built as a simple array of cascaded inverter delay elements and flip-flops, which produces time conversion resolution finer than 25 ps in the design process.

The IIR filter is a cascade of four single stage filters, each satisfying the following equation:

y[k]=(1−λ)·y[k−1]+λ·x[k] (8)

wherein

x[k] is the current input;

y[k] is the current output;

k is the time index;

λ is the configurable coefficient;

The 4-pole IIR loop filter attenuates the reference and TDC quantization noise with an 80 dB/dec slope, primarily to meet the GSM/EDGE spectral mask requirements at 400 kHz offset. The filtered and scaled phase error samples are then multiplied by the DCO gain K_{DCO} normalization factor f_{R}/\hat{K}_{DCO} via multiplier 152, where f_{R} is the reference frequency and \hat{K}_{DCO} is the DCO gain estimate, to make the loop characteristics and modulation independent from K_{DCO}. The modulating data is injected into two points of the iADPLL for direct frequency modulation, via adders 144 and 153. A hitless gear-shifting mechanism for the dynamic loop bandwidth control serves to reduce the settling time. It changes the loop attenuator α several times during the frequency locking while adding the (α₁/α₂−1)φ₁ dc offset to the phase error, where indices 1 and 2 denote before and after the event, respectively. Note that φ₁=φ₂, since the phase is to be continuous.

The frequency reference FREF is input to the retimer 166 and provides the clock for the TDC 162. The FREF input is resampled by the RF oscillator clock CKV via retimer block 166 which may comprise a flip flop or register clocked by the reference frequency FREF. The resulting retimed clock (CKR) is distributed and used throughout the system. This ensures that the massive digital logic is clocked after the quiet interval of the phase error detection by the TDC. Note that in the example embodiment described herein, the ADPLL is a discrete-time sampled system implemented with all digital components connected with all digital signals.

It is noted that the two clock domains, FREF and DCO, are not entirely synchronous and it is difficult to physically compare the two digital phase values without having to face meta-stability problems. During the frequency acquisition, their edge relationship is not known and during the phase lock the edges will exhibit rotation if the fractional FCW is non-zero. Consequently, the digital word phase comparison is performed in the same clock domain. The synchronous operation is achieved by oversampling the FREF clock using a higher rate DCO derived clock (typically CKVD8) in reference retiming circuit 165. The resulting retimed CKR clock is thus stripped of the FREF timing information and is used throughout the system. This ensures that the massive digital logic is clocked after the quiet interval of the phase error detection by the TDC.

The main advantage of representing the phase information in fixed point digital numbers is that, after the conversion it cannot be further corrupted by noise. Consequently, the phase detector could be simply realized as an arithmetic subtractor that performs an exact digital operation. Thus, having a single conversion place, where the continuously valued clock transition edge delay is quantized within the TDC, the susceptibility to noise and quantization errors is minimized and well controlled. It is emphasized that it is advantageous to operate in the phase domain for several reasons. Firstly, the phase detector used is not a conventional correlative multiplier generating reference spurs. DRP architecture uses an arithmetic subtractor 145, which does not introduce any spurs into the loop. Secondly, the dynamic range of the phase error could be made arbitrarily large simply by the increasing word length of the phase/frequency accumulators. Conventional three state phase/frequency detectors are typically limited to only ±2π of the compare rate. Thirdly, the phase domain operation is more amenable to digital implementations, contrary to the conventional approach.

As shown in FIG. 5, the oscillating frequency deviation Δf is dynamically controlled by directly modulating the DCO frequency in a feed-forward manner. The iADPLL loop compensates by effectively removing the loop dynamics from the modulating transmit path (using the reference modulation injection). The remainder of the loop, including all error sources, operates under the normal closed-loop regime. This method is similar to the conventional two-point direct modulation scheme but because of the digital nature, it is exact and does not require any analog component matching, except for the DCO gain K_{DCO}=Δf/ΔOTW calibration, which is achieved in using a robust hybrid stochastic-gradient algorithm implemented in digital domain, where the oscillator tuning word (OTW) is analogous to the voltage tuning of a VCO.

The fixed-point frequency modulating data FCW is oversampled in resampler 142 by the iADPLL DCO injection frequency f_{V}/16 and normalized in multiplier 143 to the value of iADPLL DCO injection frequency f_{V}/16. Using the direct injection of the normalized FCW directly at the DCO impacts the oscillating frequency. The PLL loop will attempt to correct this perceived frequency perturbation integrated over the update period of 1/f_{R}, which is then interpolated to the iADPLL operational frequency of in resampling interpolator 147. This corrective action is compensated by the other (compensating) reference feed that is integrated by the reference phase accumulator. If the estimated DCO gain is accurate, i.e., \hat{K}_{DCO}≅K_{DCO}, then the loop response to the modulation is flat from dc to f_{V}/64 (or half of the iADPLL operational frequency f_{V}/32). The immediate and direct DCO frequency control, made possible by accurate prediction of the DCO transfer function, is combined with the phase compensation of the PLL loop response. The two factors constitute the hybrid of predictive/closed PLL loop modulation method.

An advantage of using a direct point injection rate (e.g., channel frequency divided by 16) is that the phase modulation can be presented to the DCO with a finer resolution. For example, the phase modulation in GSM has a bandwidth of 200 kHz, while for a polar TX, in EDGE mode the phase modulation bandwidth is approximately 2.0 MHz (LB) and 1.0 MHz (HB). The CKVD16 rate corresponds to an injection frequency range of 103-124 MHz, which is at least three times higher than an FREF of 38.4 MHz, and four times higher than an FREF of 26 MHz. This implies that the phase modulation data update using a CKVD16 rate will be 3 to 4 times finer than the FREF rate used in the previous generations of ADPLL.

Furthermore, the data injection into the DCO comprises integer and fractional parts. The injection rate creates an effective zero order hold (ZOH) at resampler 142. The ZOH operation does not provide a large attenuation to the sampling replicas, which is only 13 dB lower for second harmonics and approximately 17 dB for third harmonics. As CKVD16 frequency is much higher than FREF, these replicas are correspondingly at 3 to 4 times higher frequency for CKVD16 (>100 MHz) vs. FREF (26-38.4 MHz). The DCO phase noise beyond the flicker corner of 1-2 MHz has a 20 dB/decade slope, which implies that the residual sampling replicas after ZOH 142 sync filtering will receive an additional attenuation of 12 dB using a CKVD16 injection rate as compared to FREF. In short, use of CKVD16 for direct point phase modulation injection results in pushing any sampling replicas to frequencies greater than 100 MHz from the carrier, where they are greatly attenuated by the DCO phase noise and the spectral skirt of the loop filter. Essentially these signal processing spurs are below the noise floor and cannot be seen in simulations or measurements.

Another benefit of using CKVDx, where x=16 or 8 for direct point injection is that the quality of phase modulation injection becomes independent of the FREF frequency. The same iADPLL when used with different FREFs, e.g., 26, 38.4 or 52 MHz, exhibit the same direct point injection fidelity. Note, however, that there are other noise scaling terms that are impacted by the FREF frequency change. The iADPLL loop filters, modulation injection rates etc., however, maintain their resolution across multiple possible reference frequencies.

It has been observed in previous versions of the ADPLL that the current spikes caused by clocking of bulk of the logic can be a source of spurious emissions. This is especially true for highly integrated transceivers targeted using DRP technology. For the iADPLL, a significant part of the loop filter and DCO interface logic executes in the LO derived clock domain. Since most of these frequencies are chosen to be higher than FREF, any such spurious products will have a larger intra-spur distance than FREF. For example, using CKVD32, the spurs (if present) will be 52-62 MHz apart as compared to FREF frequencies. In retrospect, the current spikes due to the modulation injection rate into DCO have the highest impact, as the rush current to the boundary level-shifters might be supplied by the same LDO supply regulator, which powers the DCO. The most critical among these spurs are the ones that appear in the corresponding GSM/EDGE RX band during transmission. The widest GSM RX band is 65 MHz, and using CKVD16 at the interface results in at most one spur appearing in the RX band due to these parasitic supply regulation issues. Therefore, the use of a higher direct-point injection frequency (>100 MHz) theoretically reduces the possibility of multiple spurs in the RX band.

### Upsampling Mechanism with Optional Time Alignment

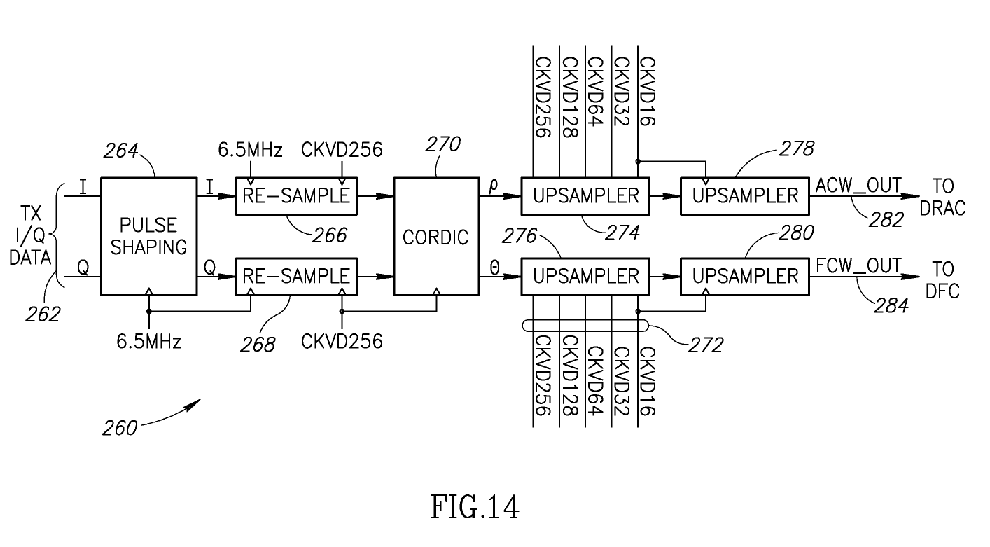

Reference is made to FIG. 14 which shows a portion of a polar transmitter signal path incorporating the upsampling mechanism of the present invention. The circuit, generally referenced 260, comprises a pulse shaping block 264 clocked at a fixed low rate of 6.5 MHz and operative to receive the TX IQ data 262, IQ re-samplers 266, 268, respectively, both of which are clocked at 6.5 MHz and the variable clock rate of CKVD256, and CORDIC 270 which functions to convert the IQ data to polar phase/frequency and amplitude information.

Selecting a relatively low sampling frequency for the pulse shaping filter 264 has the advantage of enabling a small and relatively straightforward CORDIC implementation. Note that a sampling frequency of 6.5 MHz is almost the lowest possible (3.25 is the lowest) that still yields a valid EDGE spectrum from polar amplitude and phase information. One problem with this low sampling frequency is the spectral replicas generated at every integer multiple of the sampling frequency. Since it is desirable for the receive band to be free from frequency images and spurs, the last sampling frequency used in the TX is CKVD16 which is approximately 104 MHz.

Filtering out all the images at multiples of 3.25 MHz at the last point of sampling (running at 104 MHz) is a challenging task. In addition to the requirement to be free from frequency images/spurs in the receive band, an attenuation close to −160 dBc/Hz is also required over the receive band. Therefore, any filtering/interpolating mechanism used must provide enough attenuation across the receive band. Several approaches that may be used include FIR filters, IIR filters and interpolators. Each has its drawbacks and limitations.

FIR filters have the problem of the large size of the implementation which includes multipliers and a large number of coefficients to provide the required attenuation requirements in the receive band and at the images of the 3.25 MHz sampling frequency.

IIR filters have the problem of large group delays occurring at the cutoff frequency which create potential problems in spectrum quality.

Linear interpolators have the problem of not providing sufficient attenuation of replicas to meet receive band specifications. Conventional higher order interpolators are complicated, costly and require large chip areas to implement.

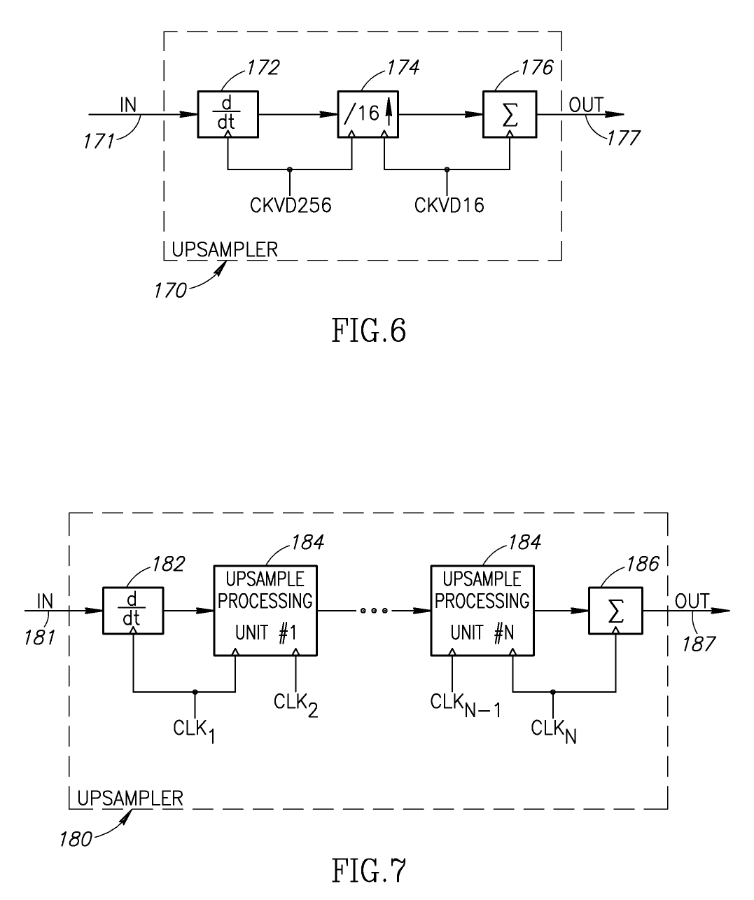

In accordance with the present invention, the filtering/interpolating mechanism comprises an upsampler structure comprising a linear interpolator in the upsampling stage. A block diagram illustrating a first example embodiment of the upsampling mechanism of the present invention is shown in FIG. 6. The upsampler circuit, generally referenced 170, comprises a differentiator 172, linear interpolator 174 and integrator 176.

In operation, the derivative block 172 is operative to differentiate (i.e. the difference between the current and previous samples) the discrete-time input sample stream 171 (IN). Linear interpolation from the CKVD256 to CKVD16 clock rates is performed by interpolator 174. The interpolated samples are integrated (i.e. summed) via integrator 176 and output (OUT signal 177).

This structure of differentiating, interpolating and integrating has several advantages. Firstly, in the application of the mechanism to a polar transmitter for use in a GSM radio, the structure inherently matches the amplitude processing path to the phase processing path up to CKVD16 (104 MHz). The phase output from the GSM pulse shaping filter is differentiated to a FCW code word at 3.25 MHz and passed to the ADPLL at a rate of 26 MHz. The ADPLL passes the FCW data through the second point of modulation to the DCO which performs the integration process at RF frequencies. Matching the amplitude and phase processing paths is crucial for maintaining spectral qualities at close-in frequencies. The ADPLL's DCO effectively performs an interpolation function. By performing the same process in the amplitude path it is ensured that both paths are matched.

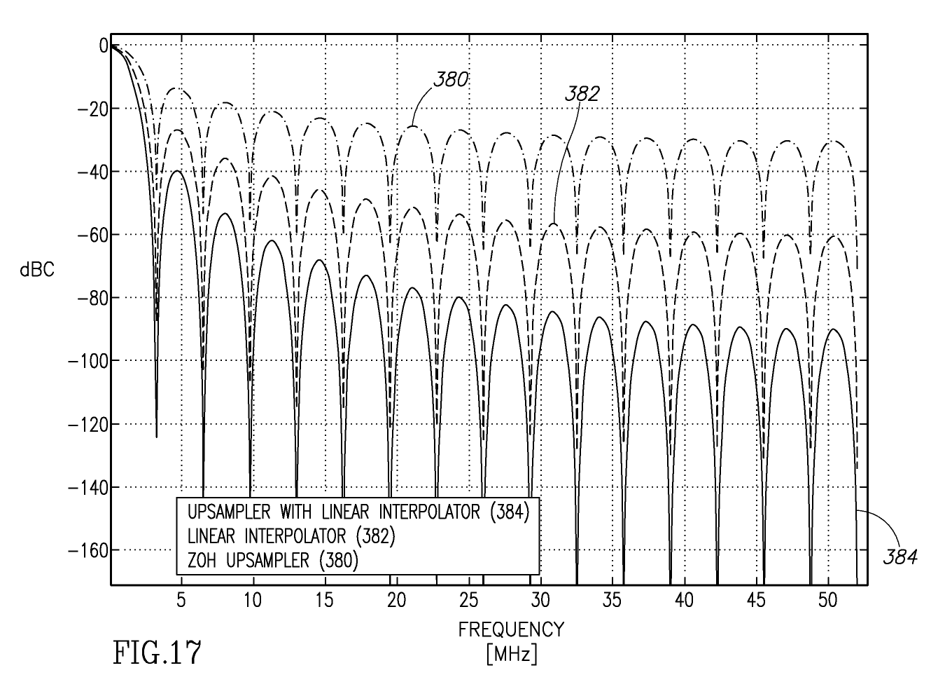

Secondly, the structure provides relatively good attenuation at receive band frequencies compared to ZOH and linear interpolators as shown in FIG. 17 wherein trace 380 represents the frequency response of a zero order hold (ZOH) upsampler, trace 382 represents the frequency response of a linear interpolator and trace 384 represents the frequency response of the upsampler of the present invention with linear interpolator (second order).

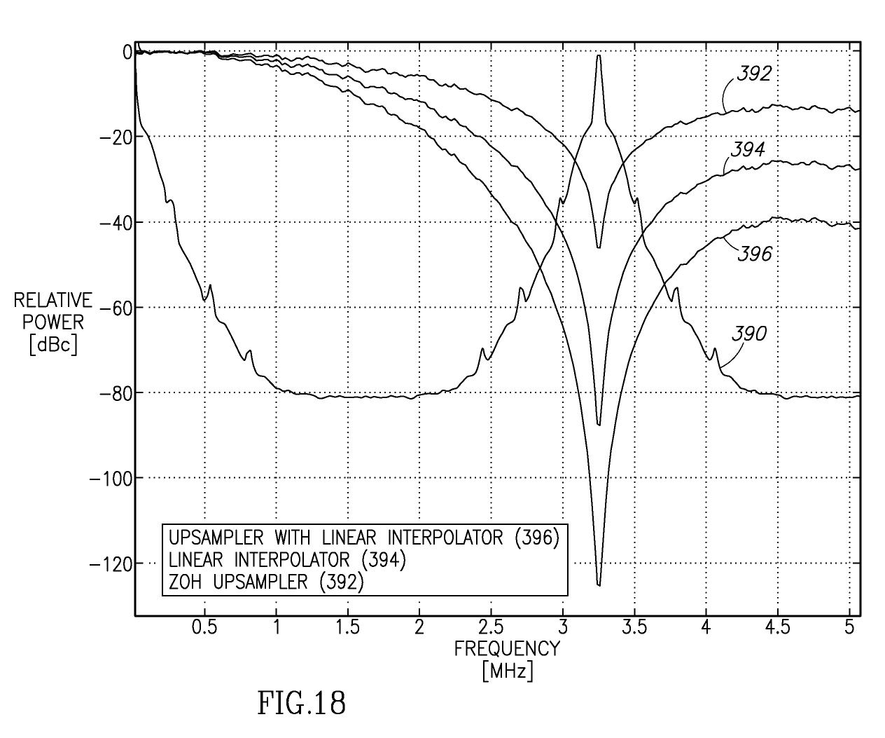

Thirdly, the structure provides wide notches at multiples of 3.25 MHz (CKVD512), compared to conventional pure linear interpolators. A graph illustrating an ACW sampling replica and the attenuation for an EDGE amplitude signal by notches from the interpolator of the present invention compared to that of prior art interpolators is shown in FIG. 18. In the figure, trace 390 represents the spectral replica (sampling spur), trace 392 represents the notch generated by a zero order hold (ZOH) upsampler, trace 394 represents the notch generated by a linear interpolator and trace 396 represents the notch generated by the upsampler of the present invention with linear interpolator (second order).

Fourthly, the structure is relatively small in chip size with reduced power consumption compared to conventional structures with the same performance. The upsampler structure can be implemented using adders without the need for any multipliers.

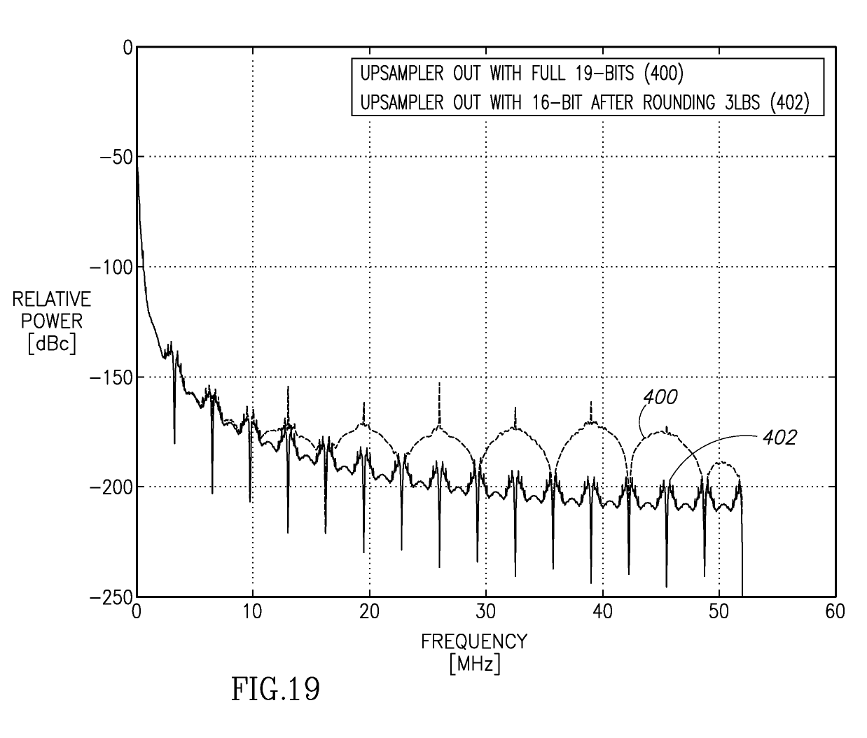

A problem with the use of the upsampler structure of FIG. 6 arises when used in a circuit incorporating rounder circuits 278, 280, for I/Q respectively (FIG. 14). A problem arises when rounding the output of the upsampling circuit 170 (FIG. 6) from 19-bits down to 16-bits. A graph illustrating the ACW spectrum of the output of the upsampler of the present invention before and after rounding of three LSBs is shown in FIG. 19, wherein trace 400 represents the spectrum of the 16-bit output of the rounder and trace 402 represents the spectrum of the full 19-bits output of the upsampler circuit before rounding.

As can be seen from the figure after rounding the 3 LSBs, the spectrum of ACW begins to exhibit spurs rising up at multiples of 3.25 MHz. In the time domain, rounding causes flat regions to appear in certain places in the signal, causing the generation of frequency spurs. In addition to the rounding problem, more frequency spurs are generated as output power decreases. This occurs because decreasing power results in a smaller ACW code, which causes more bits to be rounded out from the LSBs as the power is decreasing, resulting in more spurs.

The upsampling structure of FIG. 6 can be extended to include any number of interpolation stages to achieve different desired upsampling rates. A block diagram illustrating a second example embodiment of the upsampling mechanism of the present invention is shown in FIG. 7. The upsampler circuit, generally referenced 180, comprises a differentiator 182, one or more linear interpolator stages 184 and integrator 186.

In operation, the derivative block 182 is operative to differentiate the discrete-time input sample stream 181 (IN). Linear interpolation from the CLK1 to the CLK2 domain is performed by upsample processing unit #1, linear interpolation from the CLK2 to the CLK3 domain is performed by upsample processing unit #2 and so on to upsample processing unit #N (where N is a positive integer greater than zero) which performs linear interpolation from the CLK(N−1) to the CLK(N) domain. The interpolated samples are integrated via integrator 186 and output (OUT signal 187).

To eliminate frequency spur re-growth resulting from the rounding operation, the flat regions that result from rounding the LSBs must be eliminated. This is achieved by adding (i.e. injecting) random high frequency noise in the interpolation stage. This effectively adds noise (i.e. randomizes) to the signal that would normally cause the creation of the spurs. The noise is effective to spread out the spur over a larger frequency range effectively eliminating them. Note that dithering can also be applied to the interpolation signal to effectively spread the spectrum thereby eliminating the spurs just as achieved by adding high frequency noise to the interpolated signal.

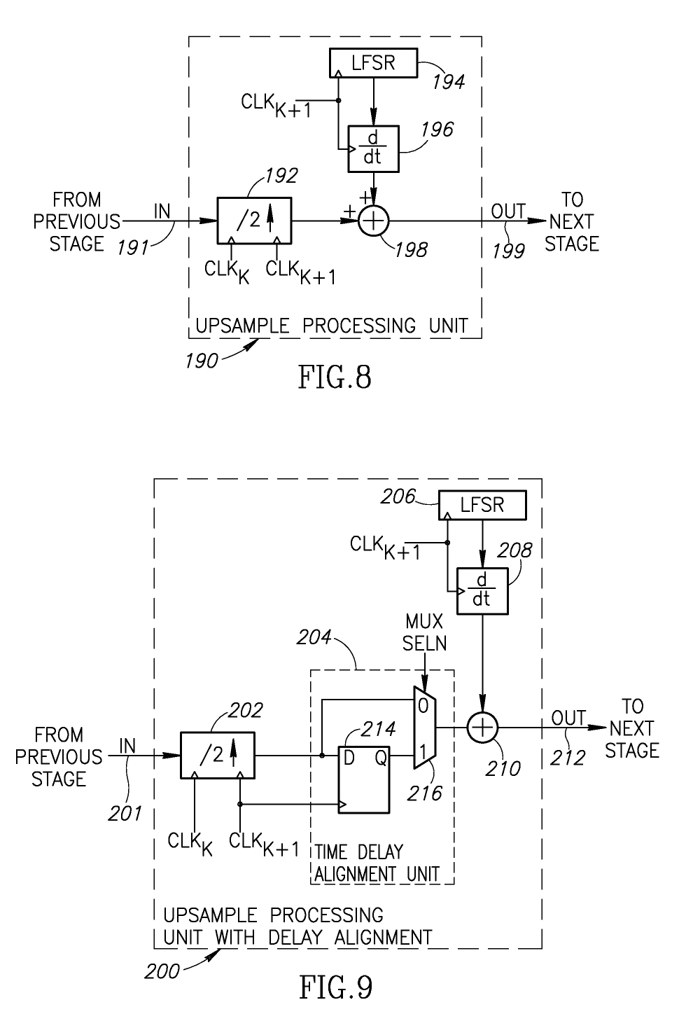

A block diagram illustrating the upsample processing unit of FIG. 7 in more detail is shown in FIG. 8. The upsample processing unit circuit, generally referenced 190, comprises a linear upsample/interpolation by two 192 block, adder 198, linear feedback shift register (LFSR) 194 and differentiator 196.

In operation, the interpolate by two circuit 192 linearly interpolates the input 191 (IN) from clock rate CLK(K) to CLK(K+1). The LFSR 194 generates a random bit stream and is clocked by the CLK(K+1) clock. Note that the invention is not limited to use of a LFSR as any means suitable for generating a random bit stream can be used. The derivative of the random bit stream is taken by the differentiator 196 which generates the high frequency noise. The high frequency noise is added to the interpolation results via adder 198 to yield the output 199 (OUT).

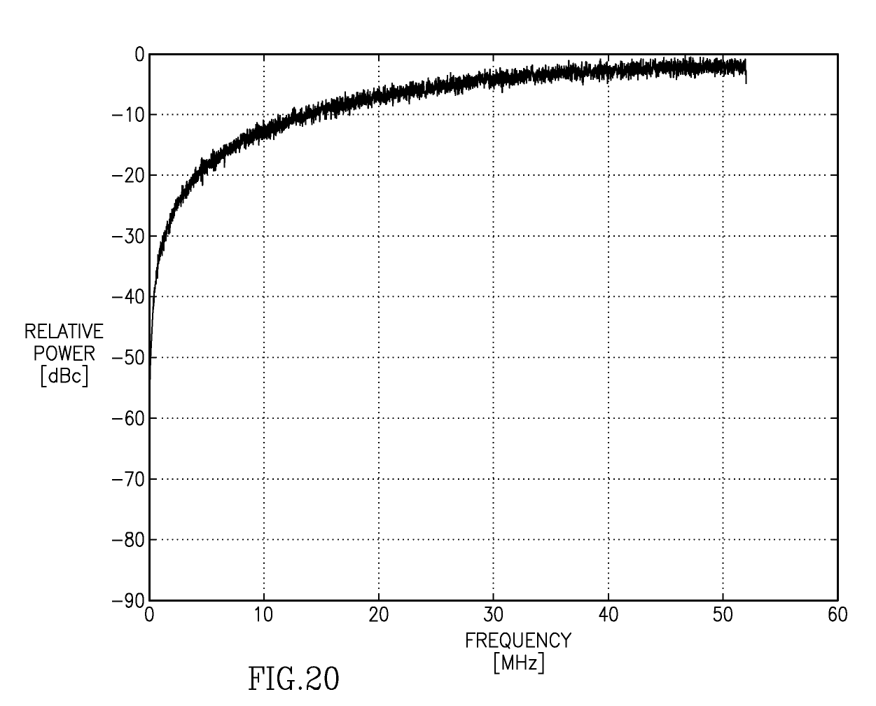

The LFSR output comprises pseudo-random signal which takes values between ‘0’ and ‘1’. Adding this signal to the output of each interpolator causes the output signal (e.g., ACW signal) to overflow and saturate. To prevent this, the LFSR output is differentiated which outputs the values −1, 0, and 1 with a mean of 0 to ensure the original signal does not end up with an offset. When the interpolated signal is subsequently passed through the integrator it will not saturate the adder. A graph illustrating example high pass random noise that is injected in each processing stage is shown in FIG. 20.

The LFSR 194, in combination with the differentiator 196 and adder 198, form the noise addition circuit. The LFSR and differentiator run at the same rate as the output of the linear interpolator. The LFSR is used to generate a random data stream of 1-bit. Examples of the PN code generator polynomial for the LFSR include, for example:

a. 1⊕z⁻⁴⊕z⁻¹³⊕z⁻¹⁵⊕z⁻¹⁶

b. 1⊕z⁻⁶⊕z⁻⁹⊕z⁻¹³⊕z⁻¹⁶

c. 1⊕z⁻¹¹⊕z⁻¹²⊕z⁻¹³⊕z⁻¹⁴⊕z⁻¹⁵⊕z⁻¹⁶

d. z⁻¹⁶

The output of the LFSR is passed through the 1-bit differentiator to convert the white noise to high pass noise. This avoids adding too much energy in the useful band of input signal. The 2-bit output of the differentiator is added with the linearly interpolated signal.

Adding the noise at the same frequency as the output of the linear interpolator functions to eliminate the repetitive pattern output of the linear interpolator and thus eliminates the replica that would have been generated at the output of the linear interpolator. For example, a linear interpolator going from CKVD256 to CKVD128 will have a strong replica at CKVD256. If the high pass LFSR noise is added at CKVD128, then that would have eliminated the repetitive signal of CKVD128 at the output of the linear interpolator and therefore eliminate the spur of CKVD256.

Such stages of linear interpolation and replica removal can be replicated as many times as needed to reach the desired high frequency. The last stage is followed by the accumulator which rungs at the same frequency as the output of the last stage of linear interpolation. The accumulator 186 is reset at the beginning of the operation and after keeps accumulating values indefinitely.

In the example embodiment presented herein, time alignment between amplitude and phase paths is achieved in several stages. A coarse time alignment block (not shown) is placed after the CORDIC with a resolution of 1/CKVD256. A finer time alignment block follows in the upsampling circuit after each interpolator stage. Performing time alignment using a plurality of alignment circuit results in a progressive fine resolution down to 1/CKVD16 (approximately 10 ns).

A block diagram illustrating the upsample processing unit of FIG. 7 incorporating delay alignment in more detail is shown in FIG. 9. The upsample processing unit circuit, generally referenced 200, comprises a linear upsample/interpolation by two 202 block, time delay alignment unit 204, adder 210, linear feedback shift register (LFSR) 206 and differentiator 208. The time alignment unit 204 comprises flip flop 214 and multiplexer 216.

In operation, the interpolate by two circuit 202 linearly interpolates the input 201 (IN) from clock rate CLK(K) to CLK(K+1). The time alignment unit stores the current interpolation result in unit delay register 214. At each clock cycle, the multiplexer 216 passes either the delayed (i.e. previous) interpolation results output of register 214 or the current interpolation results in accordance with a mux select control signal.

The LFSR 206 generates a random bit stream and is clocked by the CLK(K+1) clock. Note that the invention is not limited to use of a LFSR as any means suitable for generating a random bit stream can be used. The derivative of the random bit stream is taken by the differentiator 208 which generates the high frequency noise. The high frequency noise is added to the output of the multiplexer 216 via adder 210 to yield the output 212 (OUT).

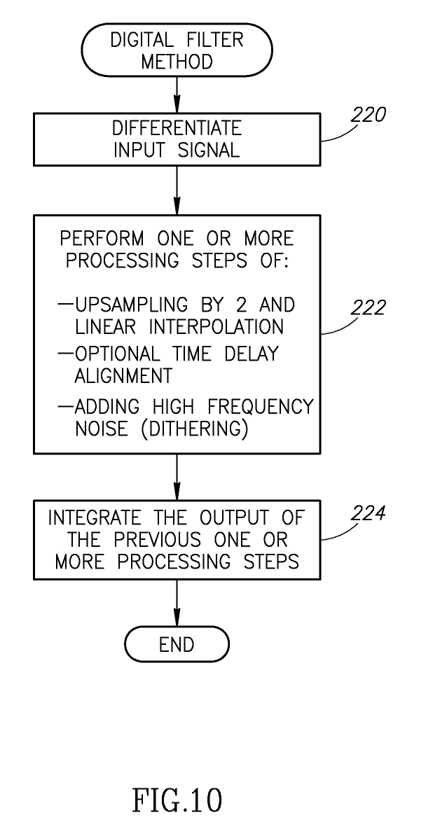

Depending on the implementation, the upsample mechanism of the present invention may be implemented in hardware, software or a combination thereof. A flow diagram illustrating the upsampling method of the present invention for use in a software implementation is shown in FIG. 10. The discrete-time input sample stream is first differentiated (step 220). Then the differentiated samples are upsampled by two using linear interpolation (step 222). Note that any number of upsample by two stages may be used. Optional time alignment is then performed where either the current interpolated data or the previous interpolated data is passed to the subsequent upsample processing stage. High frequency noise is then optionally added, i.e. dithering is applied, to the interpolated samples (or delayed samples) to compensate in the case of rounding. The output of the last upsample processing stage is integrated to yield the upsampled output samples (step 224).

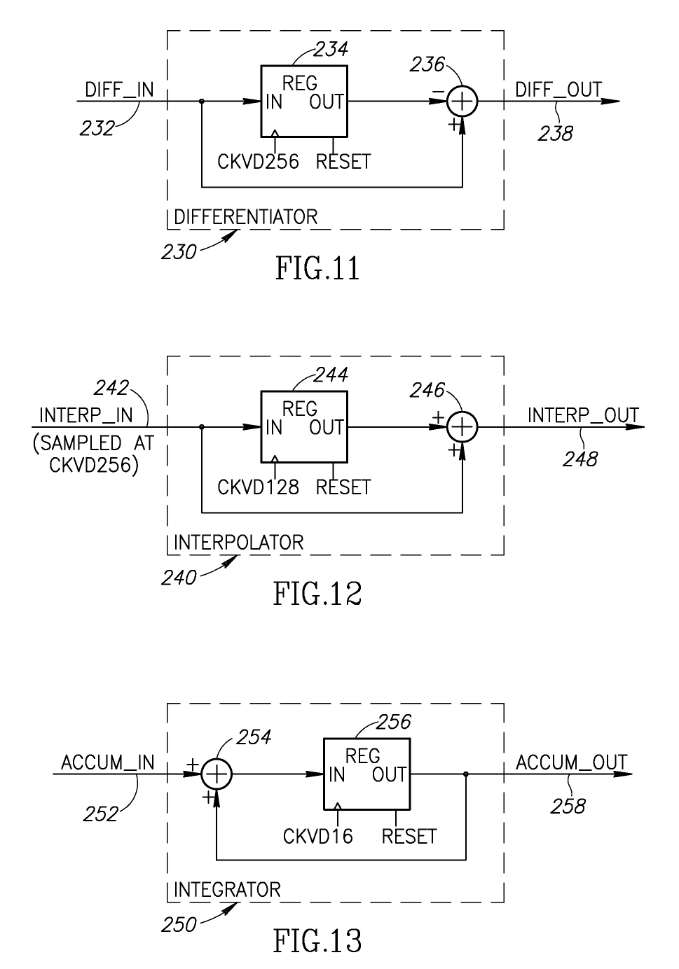

Example circuits for the differentiator, interpolator and integrator blocks suitable for use with the present invention will now be described. A diagram illustrating an example differentiator of the present invention is shown in FIG. 11. The differentiator, generally referenced 230, comprises a register 234 and adder 236.

In operation, input signal DIFF_IN 232 is coupled to the input of the register which is clocked, for example, by CKVD256, and to one input of the adder 236. The output of the adder yields the DIFF_OUT 238 signal. At each clock cycle, the previous sample is subtracted from the current sample resulting in a difference output sample stream.

A diagram illustrating an example interpolator of the present invention is shown in FIG. 12. The interpolator, generally referenced 240, comprises a register 244 and adder 246.

In operation, input signal INTERP_IN 242 (clocked at CKVD256 rate in the first stage) is coupled to the input of the register which is clocked, for example, by CKVD128 (twice the rate of the CKVD256 clock), and to one input of the adder 246. The output of the adder yields the INTERP_OUT 248 signal. The current sample, which changes every two clock cycles of the CKVD128 clock, is clocked into the register. At each CKVD128 clock cycle, the current sample is added to the contents stored in the register resulting in the interpolated output sample stream.

A diagram illustrating an example integrator of the present invention is shown in FIG. 13. The integrator, generally referenced 250, comprises an adder 254 and register 256.

In operation, input signal ACCUM_IN 252 is input to the one input of the adder 254. The output of the register 256 constitutes the output ACCUM_OUT 258 of the circuit and is also fed back to the other input of the adder 254. The output of the adder is clocked into the register which is clocked at the CKVD16 rate. At each clock cycle, the previous sum stored in the register is added to the current input sample to yield an accumulated sum or integration result output sample stream.

A block diagram illustrating a portion of a polar transmitter signal path incorporating the upsampling mechanism of the present invention is shown in FIG. 14. The circuit, generally referenced 260, comprises a pulse shaping block 264 clocked at a fixed low rate of 6.5 MHz and operative to receive the TX IQ data 262, IQ re-samplers 266, 268, respectively, both of which are clocked at 6.5 MHz and the variable clock rate of CKVD256, CORDIC 270 which functions to convert the IQ data to polar phase/frequency and amplitude information, amplitude upsampler 274, phase/frequency upsampler 276, and rounders 278, 280.

The circuit 260 shows a portion of a polar transmitter signal path incorporating the upsampling mechanism of the present invention. As described supra, the pulse shaping and CORDIC processing functions are performed at relatively low clock rates to reduce the complexity and cost of the required circuitry. After the conversion from IQ to polar representation, the amplitude and phase/frequency information must be upsampled to the variable clock rate of the ADPLL (e.g., CKVD16) via upsamplers 274, 276, respectively. In accordance with the invention, to simplify the circuitry and prevent spectral re-growth, the upsampling and interpolation is performed in multiple steps, wherein each step performs upsampling by a factor of two. Thus, in this example embodiment, the sampling rate is increased from CKVD256 to CKVD16. Each upsampler thus requires clocks CKVD256, CKVD128, CKVD64, CKVD32 and CKVD16 (clock group 272).

The output of upsampler 274 is rounded via rounder 278 to yield the amplitude control word ACW_OUT 282 which is output to the DRAC. The output of upsampler 276 is rounded via rounder 280 to yield the frequency control word FCW_OUT 284 which is output to the DFC.

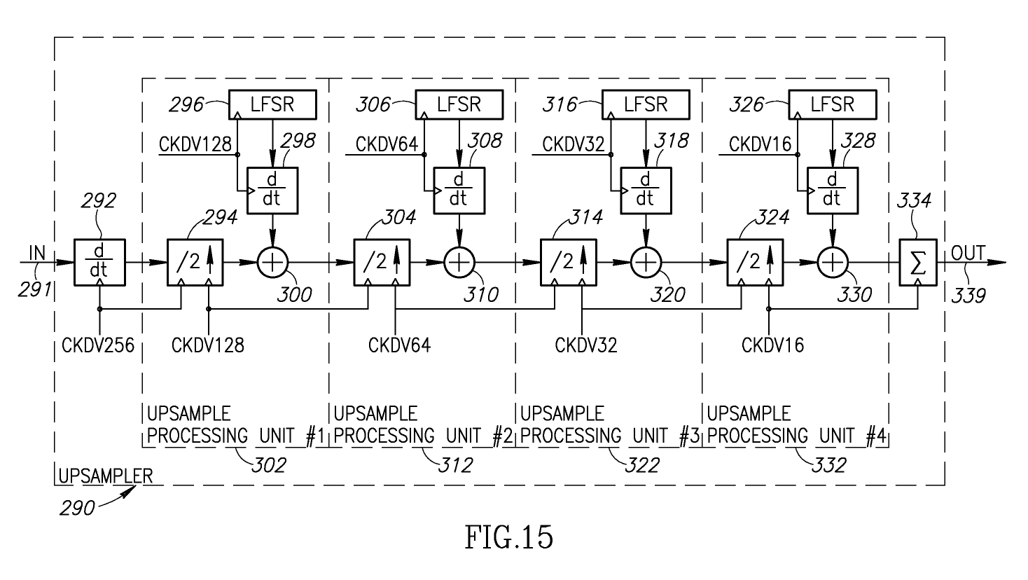

A block diagram illustrating a third example embodiment of the upsampling mechanism of the present invention is shown in FIG. 15. The upsampler circuit, generally referenced 290, comprises differentiator 292 adapted to receive the discrete-time input sample stream IN 291, four cascaded upsample processing units #1 302, #2 312, #3 322 and #4 332 and integrator 334 adapted to generate the output sample stream OUT 339. Upsample processing unit #1 302 comprises upsample/interpolation by two block 294, adder 300, LFSR 296 and differentiator 298. Upsample processing unit #2 312 comprises upsample/interpolation by two block 304, adder 310, LFSR 306 and differentiator 308. Upsample processing unit #3 322 comprises upsample/interpolation by two block 314, adder 320, LFSR 316 and differentiator 318. Upsample processing unit #4 332 comprises upsample/interpolation by two block 324, adder 330, LFSR 326 and differentiator 328.

In operation, upsample processing units #1 to #4 operate similarly as upsample processing unit 190 (FIG. 8) described supra. Each cascaded upsample processing unit increases the sampling rate by a factor of two in accordance with the clock inputs, wherein unit #1 receives clock CKVD128, unit #2 receives clock CKVD64, unit #3 receives clock CKVD32 and unit #4 receives clock CKVD16.

Effectively, upsample circuit 290 implements a linear interpolator by 16. In accordance with the invention, the linear interpolation by 16 is divided into four cascaded linear interpolators by 2 and adds high pass LFSR random signals in each interpolator stage. It is appreciated that the invention is not limited to an upsample circuit of four cascaded upsample processing units, as an upsampler having any number of desired processing unit stages can be constructed without departing from the scope of the invention.

Note that the LFSR output is pseudo-random signal having values between ‘0’ and ‘1’. Adding this signal to the output of each interpolator causes the output signal to overflow and saturate when rounded. Thus, the LFSR is differentiated which yields values between −1, 0, and 1 with mean of 0. When the signal passes through the integrator does not saturate the adder 254 (FIG. 13) within the integrator.

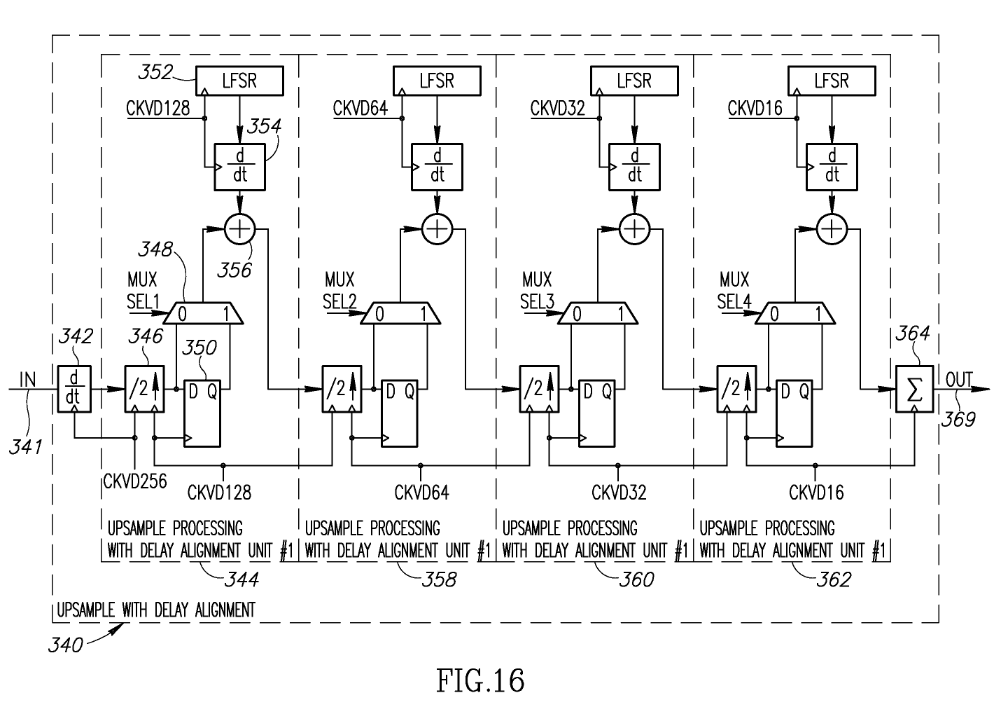

A block diagram illustrating a fourth example embodiment of the upsampling mechanism of the present invention is shown in FIG. 16. The upsampler circuit, generally referenced 340, comprises differentiator 342 adapted to receive the discrete-time input sample stream IN 341, four cascaded upsample processing units with delay alignment #1 344, #2 358, #3 360 and #4 362 and integrator 364 adapted to generate the output sample stream OUT 369. Each upsample processing unit with delay alignment comprises upsample/interpolation by two block 346, multiplexer 348, register 350, adder 356, LFSR 352 and differentiator 354.

In operation, upsample processing units with delay alignment #1 to #4 operate similarly as upsample processing unit with delay alignment 200 (FIG. 9) described supra. Each cascaded upsample processing unit with delay alignment increases the sampling rate by a factor of two in accordance with the clock inputs, wherein unit #1 receives clock CKVD128, unit #2 receives clock CKVD64, unit #3 receives clock CKVD32 and unit #4 receives clock CKVD16.

In accordance with the invention, time alignment between amplitude and phase is achieved in several stages. In the example polar transmitter presented herein, a coarse time alignment block is placed after the CORDIC with a resolution of 1/CKVD256. Finer time alignment blocks follow subsequently in the upsample circuit block in each upsample/interpolator stage. This achieves a progressive fine resolution down to 1/CKVD16, which is in the order of approximately 10 ns.

In operation, each unit potentially delays the signal in accordance with its binary-weighted respective mux select control. In particular, the delay multiplexer in unit #1 is controlled by MUX SEL1, in unit #2 by MUX SEL2, in unit #3 by MUX SEL3 and in unit #4 by MUX SEL4. The mux select control signals typically would be provided by a controller, circuit or other means such as an upper layer control/management entity.

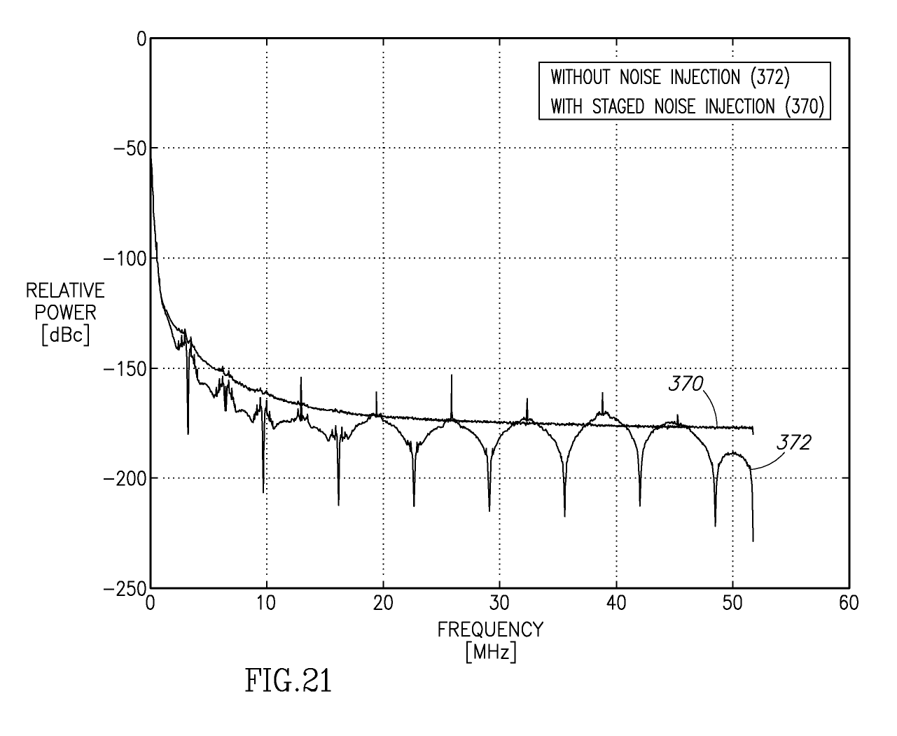

An example amplitude control word (ACW) spectral plot with and without the addition of noise in the interpolator stages of the upsampler is shown in FIG. 21. Trace 370 represents the ACW frequency spectrum with the staged high pass noise injection (generated by the LFSRs) of the present invention after rounding the 3 LSBs. Trace 372 represents the ACW spectrum without high pass noise injection. Note the marked difference between the traces wherein spectral re-growth is virtually eliminated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of increasing the sampling rate of a discrete-time input sample stream, said method comprising the steps of:
differentiating said input samples to generate differentiated samples therefrom;
upsampling and interpolating said differentiated samples to generate interpolated samples therefrom; and
integrating said interpolated samples to generate upsampled output samples therefrom.

2. The method according to claim 1, wherein said upsampling is by a power of two.

3. The method according to claim 1, wherein said upsampling is by two.

4. The method according to claim 1, wherein said step of upsampling and interpolating comprises a plurality of upsampling and interpolating stages.

5. The method according to claim 1, further comprising the step of adding noise to said interpolated samples.

6. The method according to claim 5, wherein said step of adding noise comprises the step of dithering said interpolated samples.

7. The method according to claim 5, wherein said step of adding noise comprises the step of adding high pass noise to said interpolated samples.

8. The method according to claim 1, further comprising the step of rounding said output samples to generate rounded output samples therefrom.

9. The method according to claim 1, wherein said step of upsampling and interpolating comprises the step of rounding said interpolated samples.

10. A method of increasing the sampling rate of a discrete-time input sample stream, said method comprising the steps of:
differentiating said input samples to generate differentiated samples therefrom;
upsampling and interpolating said differentiated samples to generate interpolated samples therefrom;
delaying said interpolated samples by a predetermined duration to generate delayed samples therefrom; and
integrating said delayed samples to generate upsampled output samples therefrom.

11. The method according to claim 10, wherein said upsampling is by a power of two.

12. The method according to claim 10, wherein said upsampling is by two.

13. The method according to claim 10, wherein said step of upsampling and interpolating and delaying comprises a plurality of upsampling and interpolating and delaying stages.

14. The method according to claim 10, further comprising the step of adding noise to said delayed samples.

15. The method according to claim 14, wherein said step of adding noise comprises the step of dithering said delayed samples.

16. The method according to claim 14, wherein said step of adding noise comprises the step of adding high pass noise to said delayed samples.

17. The method according to claim 10, further comprising the step of rounding said output samples to generate rounded output samples therefrom.

18. A multi-rate digital filter, comprising:
a differentiator operative to receive a discrete-time input sample stream and to generate differentiated samples therefrom;
one or more cascaded upsampling units coupled to said differentiator, each upsampling unit comprising:
an upsampler operative to upsample and interpolate samples to generate interpolated samples therefrom; and
an integrator operative to integrate the output of said one or more cascaded upsampling units to generate upsampled output samples therefrom.

19. The multi-rate digital filter according to claim 18, wherein said upsampler is operative to upsample by a power of two.

20. The multi-rate digital filter according to claim 18, wherein said upsampler is operative to upsample by two.

21. The multi-rate digital filter according to claim 18, wherein one or more said upsampling units further comprise means for adding noise to said interpolated samples.

22. The multi-rate digital filter according to claim 21, wherein said means for adding noise comprises means for dithering said interpolated samples.

23. The multi-rate digital filter according to claim 21, wherein said means for adding noise comprises means for adding high pass noise to said interpolated samples.

24. The multi-rate digital filter according to claim 18, further comprising a rounder operative to round said output samples to generate rounded output samples therefrom.

25. The multi-rate digital filter according to claim 18, wherein said upsampling units comprise a rounder operative to round said interpolated samples.

26. A multi-rate digital filter, comprising:
a differentiator operative to receive a discrete-time input sample stream and to generate differentiated samples therefrom;
one or more cascaded upsampling units coupled to said differentiator, each upsampling unit comprising:
an upsampler operative to upsample and interpolate samples to generate interpolated samples therefrom;
a delay alignment unit operative to delay said interpolated samples by a predetermined duration to generate delayed samples therefrom; and
an integrator operative to integrate the output of said one or more cascaded upsampling units to generate upsampled output samples therefrom.

27. The multi-rate digital filter according to claim 26, wherein said upsampler is operative to upsample by a power of two.

28. The multi-rate digital filter according to claim 26, wherein said upsampler is operative to upsample by two.

29. The multi-rate digital filter according to claim 26, wherein said upsampling units further comprise means for adding noise to said delayed samples.

30. The multi-rate digital filter according to claim 29, wherein said means for adding noise comprises means for dithering said delayed samples.

31. The multi-rate digital filter according to claim 29, wherein said means for adding noise comprises means for adding high pass random noise to said delayed samples.

32. The multi-rate digital filter according to claim 26, further comprising a rounder operative to round said output samples to generate rounded output samples therefrom.

33. A polar radio frequency (RF) transmitter (TX), comprising:
means for generating a discrete-time frequency command word (FCW) signal and a discrete-time amplitude command word (ACW) signal in accordance with input TX IQ data samples;
a first multi-rate digital filter operative to increase the sampling rate of said FCW signal by upsampling and interpolating said FCW signal to generate an upsampled FCW signal therefrom;
a second multi-rate digital filter operative to increase the sampling rate of said ACW signal by upsampling and interpolating said ACW signal to generate an upsampled ACW signal therefrom;
a frequency synthesizer operative to generate an RF signal having a frequency in accordance with a frequency reference input and said upsampled FCW signal; and
a digital power amplifier (DPA) operative to receive said RF signal and to generate a modulated RF output signal in proportion to said upsampled ACW signal.

34. The polar transmitter according to claim 33, wherein said first digital filter and said second digital filter are operative to upsample by a power of two.

35. The polar transmitter according to claim 33, wherein said first digital filter and said second digital filter are operative to upsample by two.

36. The polar transmitter according to claim 33, wherein said first digital filter and said second digital filter further comprise means for adding noise to interpolated samples.

37. The polar transmitter according to claim 36, wherein said means for adding noise comprises means for dithering interpolated samples.

38. The polar transmitter according to claim 36, wherein said means for adding noise comprises means for adding high pass noise to interpolated samples.

39. The polar transmitter according to claim 33, wherein said first digital filter and said second digital filter further comprise a rounder operative to round said upsampled signals to generate rounded upsampled signals therefrom.

40. The polar transmitter according to claim 33, wherein said first digital filter and/or said second digital filter further comprise at least one delay unit operative to delay interpolated samples by a predetermined duration.

41. A single chip radio, comprising:
a phase locked loop (PLL);
a transmitter coupled to said phase locked loop, said transmitter comprising:
means for generating a discrete-time frequency command word (FCW) signal and a discrete-time amplitude command word (ACW) signal in accordance with input transmitter IQ data samples;
a first multi-rate digital filter operative to increase the sampling rate of said FCW signal by upsampling and interpolating said FCW signal to generate a filtered FCW signal therefrom;
a second multi-rate digital filter operative to increase the sampling rate of said ACW signal by upsampling and interpolating said ACW signal to generate a filtered ACW signal therefrom;
a frequency synthesizer operative to generate an RF signal having a frequency in accordance with a frequency reference input and said filtered FCW signal;
a digital power amplifier (DPA) operative to receive said RF signal and to generate a modulated RF output signal in proportion to said filtered amplitude command signal;
a receiver coupled to said phase locked loop; and
a baseband processor coupled to said transmitter and said receiver.

42. The radio according to claim 41, wherein said transmitter further comprises means for adding noise to interpolated samples.

43. The polar transmitter according to claim 41, wherein said first digital filter and said second digital filter further comprise a rounder operative to round said filtered signals to generate rounded filtered signals therefrom.

44. The polar transmitter according to claim 41, wherein said first digital filter and said second digital filter further comprise a delay unit operative to delay interpolated samples by a predetermined duration.

45. The polar transmitter according to claim 41, wherein delay value of said delay unit is set to maximize said transmitter performance.
